(19) United States
(12) Patent Application Publication
(10) Pub. No.: US 2026/0223128 A1
(43) Pub. Date: Jul. 30, 2026

(54) METHOD AND APPARATUS FOR ON DEMAND SYNCHRONIZATION SIGNAL BLOCK TRANSMISSION AND RECEPTION IN MOBILE WIRELESS COMMUNICATION SYSTEM

(71) Applicant: SETLAB Co., LTD., Gyeonggi-do (KR)

(72) Inventor: Soenghun KIM, Gyeonggi-do (KR)

(21) Appl. No.: 19/457,178

(22) Filed: Jan. 23, 2026

(30) Foreign Application Priority Data
Jan. 28, 2025 (KR) 10-2025-0012119
Jan. 16, 2026 (KR) 10-2026-0009337

(51) Int. Cl. H04W 72/231; H04W 56/00

(52) U.S. Cl. CPC H04W 72/231; H04W 56/0015

(57) ABSTRACT

Disclosed are a method and terminal for on-demand synchronization signal block (OD-SSB) activation. The terminal receives an RRC message and MAC CE containing a bitmap from a base station, and activates the OD-SSB when a bit corresponding to an SCell index is set to one. The terminal then sets up an OD-SSB specific SMTC. OD-SSB transmission timing is determined based on PUCCH transmission and RRC parameters including time offset, periodicity, frequency, and initial state. Multiple OD-SSB groups can be transmitted within half-frames for flexible operation.

### CROSS-REFERENCE TO RELATED APPLICATION

This application claims priority to and the benefit of Korean Patent Application Nos. 10-2025-0012119, filed on Jan. 28, 2025, and 10-2026-0009337, filed on Jan. 16, 2026. Each of the above documents is incorporated herein by reference in its entirety.

### BACKGROUND

### Technical Field

The present disclosure relates to synchronization signal transmission for network energy efficiency in a mobile communication system.

### Related Art

To meet the increasing demand for wireless data traffic since the commercialization of 4th generation (4G) communication systems, the 5th generation (5G) system is being developed. 5G system introduced millimeter wave (mmW) frequency bands (e.g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability.

In the advancement of 5G networks, one significant focus is improving network energy efficiency. A key innovation in this area is Synchronization Signal Block (SSB) transmission.

SSBs are critical components in 5G NR (New Radio) that carry essential information for cell search, signal synchronization, and initial access procedures. They enable User Equipment (UE) to discover and connect to the network.

Traditionally, SSBs are broadcast periodically at fixed intervals, regardless of whether any UEs are present or attempting to access the network.

Periodic transmission of SSBs degrades network energy efficiency especially in low load/traffic scenario.

### SUMMARY

The present disclosure relates to methods and apparatus for on-demand synchronization signal block (OD-SSB) transmission and reception in wireless communication systems, particularly in 5G New Radio (NR) networks supporting carrier aggregation with multiple serving cells.

In one aspect, a method performed by a terminal is provided. The method comprises receiving a radio resource control (RRC) message from a base station, and receiving a medium access control (MAC) control element (CE) for activating an on-demand synchronization signal block (OD-SSB) from the base station. The terminal activates the OD-SSB in a specific bandwidth part of a specific serving cell when a specific bit of a bitmap included in the MAC CE is set to one. The bit position of the specific bit is determined based on a Secondary Cell (SCell) index of the serving cell, enabling selective activation of OD-SSB for different serving cells. Upon activation of the specific serving cell, the terminal sets up an OD-SSB specific Synchronization Signal/Physical Broadcast Channel (SS/PBCH) block measurement timing configuration (SMTC) to facilitate proper synchronization and measurement operations.

The transmission timing of the OD-SSB is carefully coordinated. Specifically, the transmission of the OD-SSB starts at a specific point of time that is determined based on Physical Uplink Control Channel (PUCCH) transmission for the MAC CE and an OD-SSB parameter for offset indicated in the RRC message. This ensures proper timing alignment between the activation command acknowledgment and the actual OD-SSB transmission.

The method further supports transmission of multiple OD-SSB groups. The number of OD-SSB groups to be transmitted is determined based on a parameter indicated in the RRC message, providing flexibility in configuring the amount of synchronization signaling. Each OD-SSB group comprises a plurality of OD-SSBs transmitted within the same half-frame, allowing for efficient burst transmission of synchronization signals.

The RRC message used for OD-SSB configuration comprises several critical parameters. These include an OD-SSB parameter for offset indicating the time offset between OD-SSB transmission and OD-SSB activation command reception, an OD-SSB parameter indicating periodicity for repeated transmissions, an OD-SSB parameter indicating absolute frequency of the OD-SSB to specify the frequency location, and an OD-SSB parameter indicating the initial state of the OD-SSB. These parameters provide comprehensive configuration capabilities for flexible OD-SSB operation tailored to different deployment scenarios and network requirements.

In another aspect, a terminal apparatus is provided comprising a transceiver and a controller configured to perform the operations described in the method above.

The disclosed technology enables efficient and flexible on-demand transmission of synchronization signals, reducing overhead compared to periodic SSB transmission while maintaining synchronization performance. This is particularly beneficial in scenarios with multiple serving cells where synchronization signals may not be continuously needed, thereby improving spectrum efficiency and reducing power consumption for both the base station and the terminal.

### BRIEF DESCRIPTION OF THE DRAWINGS

FIG. 1 is a diagram illustrating the architecture of an 5G system and a NG-RAN;

FIG. 2 is a diagram illustrating a wireless protocol architecture in an 5G system;

FIG. 3 illustrates the overall operation of the UE and network.

FIG. 4 illustrates RRC connection establishment procedure.

FIG. 5 illustrates UE capability transfer procedure.

FIG. 6 illustrates RRC connection reconfiguration procedure.

FIG. 7 illustrates data transfer procedure in RRC_CONNECTED state.

FIG. 8 illustrates SS/PBCH block.

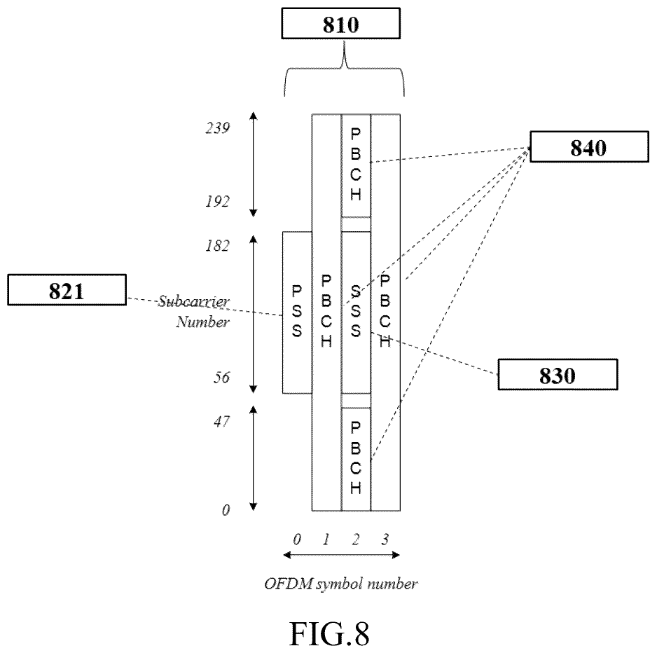

FIG. 9 illustrates the operation of the UE and network for SIB-less secondary cell.

FIG. 10 illustrates the operation of the UE and network for assistance information transfer.

FIG. 11 illustrates the operation of the UE and network for on-demand SSB.

FIG. 12 illustrates the format of OD-SSB activation/deactivation MAC CE.

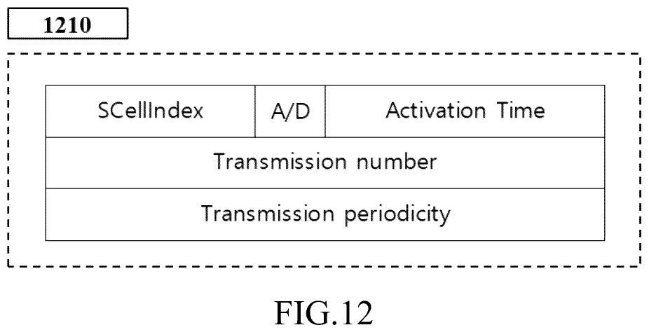

FIG. 13 illustrates the operation of the UE and network for on-demand SSB.

FIG. 14 illustrates on-demand SSB and always-on SSB.

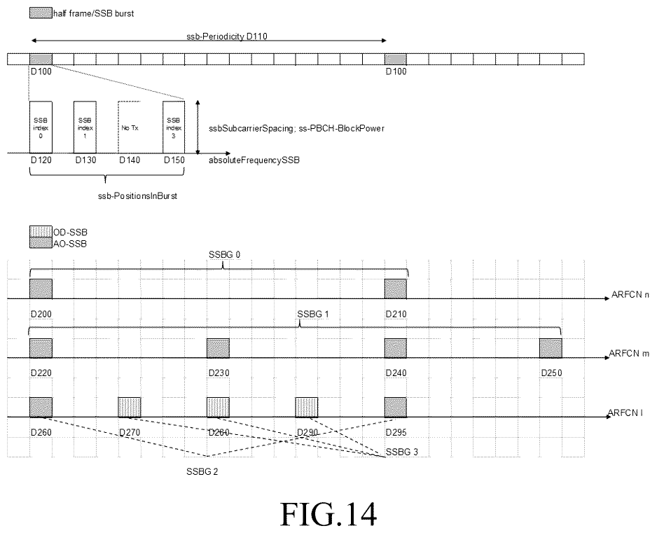

FIG. 15 illustrates various types of SSBs.

FIGS. 16A, 16B, 16C, and 16D illustrate ASN.1 structure of various IEs.

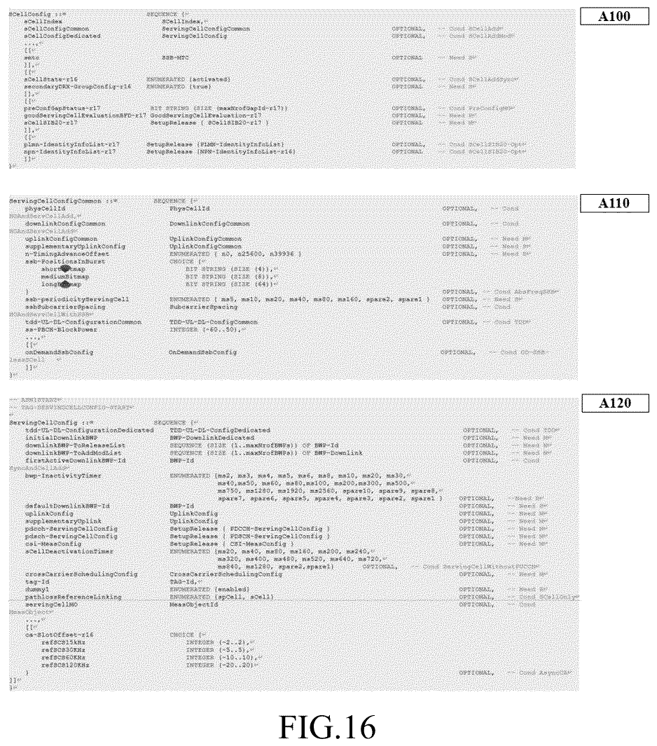

FIGS. 17A, 17B, 17C, and 17D illustrate ASN.1 structure of various IEs.

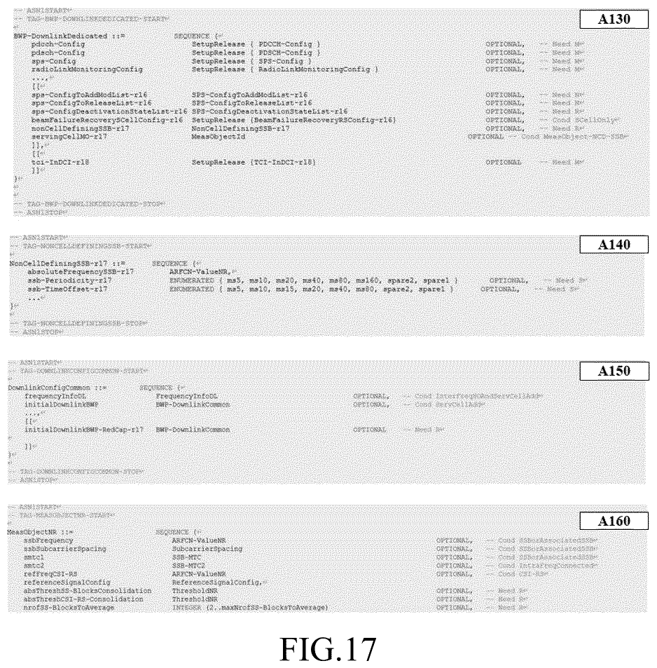

FIG. 18 illustrates another format of OD-SSB activation/deactivation MAC CE.

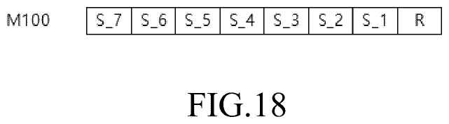

FIG. 19 is a diagram illustrating UE operations for on-demand SSB.

FIG. 20 is a diagram illustrating base station operations for on-demand SSB.

FIG. 21 is a block diagram illustrating the internal structure of a UE to which the disclosure is applied.

FIG. 22 is a block diagram illustrating the configuration of a base station according to the disclosure.

### DETAILED DESCRIPTION

SSBs are critical components in 5G NR (New Radio) that carry essential information for cell search, signal synchronization, and initial access procedures. They enable User Equipment (UE) to discover and connect to the network.

Traditionally, SSBs are broadcast periodically at fixed intervals, regardless of whether any UEs are present or attempting to access the network, which results in unnecessary network energy consumption. One solution to remedy this problem is demand-driven SSB transmission.

On-demand SSB transmission represents a significant step towards sustainable and efficient 5G networks. By aligning signal transmissions with actual demand, networks can drastically reduce energy consumption without compromising connectivity. This approach not only benefits network operators through cost savings but also supports global efforts in reducing the carbon footprint of telecommunications infrastructure. To enable demand driven SSB transmission, new hardware, signaling and protocol are required.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

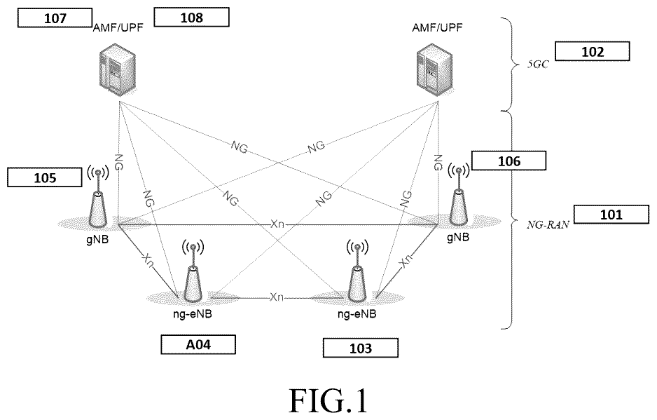

FIG. 1 is a diagram illustrating the architecture of an 5G system and a NG-RAN to which the disclosure may be applied.

5G system consists of NG-RAN 101 and 5GC 102. An NG-RAN node is either:
1: a gNB, providing NR user plane and control plane protocol terminations towards the UE; or
1: an ng-eNB, providing E-UTRA user plane and control plane protocol terminations towards the UE.

The gNBs 105 or 106 and ng-eNBs 103 or 104 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 107 and UPF 108 may be realized as a physical node or as separate physical nodes.

A gNB 105 or 106 or an ng-eNBs 103 or 104 hosts the various functions listed below.
1: Functions for Radio Resource Management such as Radio Bearer Control, Radio Admission Control, Connection Mobility Control, Dynamic allocation of resources to UEs in uplink, downlink and sidelink (scheduling); and
1: IP and Ethernet header compression, uplink data decompression and encryption of user data stream; and
1: Selection of an AMF at UE attachment when no routing to an MME can be determined from the information provided by the UE; and
1: Routing of User Plane data towards UPF; and
1: Scheduling and transmission of paging messages; and
1: Scheduling and transmission of broadcast information (originated from the AMF or O&M); and
1: Measurement and measurement reporting configuration for mobility and scheduling; and
1: Session Management; and
1: QoS Flow management and mapping to data radio bearers; and
1: Support of UEs in RRC_INACTIVE state; and

The AMF 107 hosts the functions such as NAS signaling, NAS signaling security, AS security control, SMF selection, Authentication, Mobility management and positioning management.

The UPF 108 hosts the functions such as packet routing and forwarding, transport level packet marking in the uplink, QoS handling and the downlink, mobility anchoring for mobility etc.

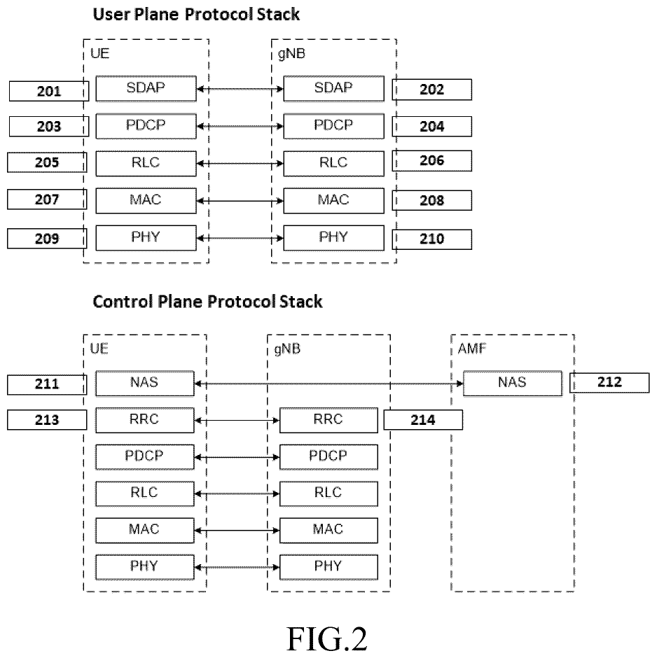

FIG. 2 is a diagram illustrating a wireless protocol architecture in an 5G system to which the disclosure may be applied.

The user plane protocol stack consists of SDAP 201 or 202, PDCP 203 or 204, RLC 205 or 206, MAC 207 or 208 and PHY 209 or 210. The control plane protocol stack consists of NAS 211 or 212, RRC 213 or 214, PDCP, RLC, MAC and PHY.

Each protocol sublayer performs functions related to the operations listed below.

NAS: authentication, mobility management, security control etc

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

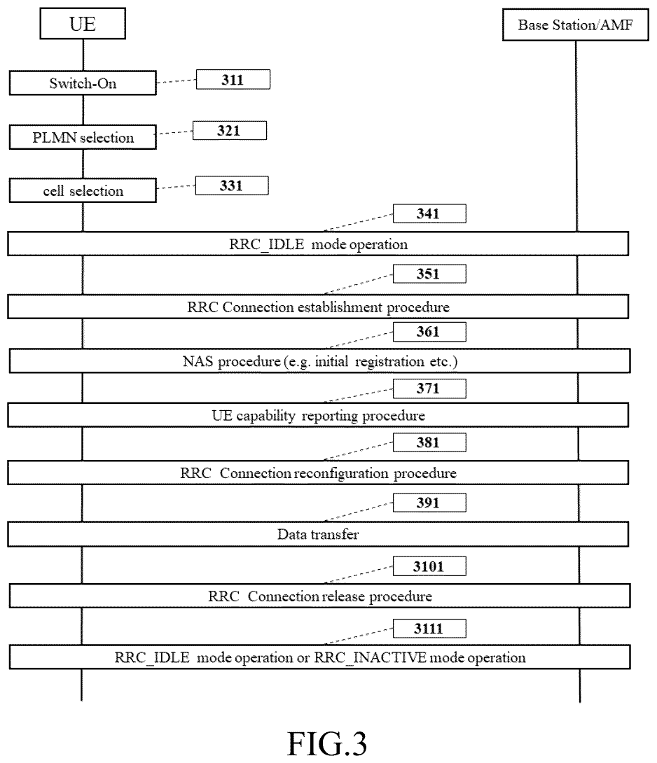

FIG. 3 illustrates overall operation of the UE and network.

Upon switch-on of the wireless device (e.g. UE) 311, UE performs PLMN selection 321 to select the carrier that is provided by the PLMN that UE is allowed to register.

Then UE performs cell selection 331 to camp on a suitable cell.

Once camping on a suitable cell, UE performs RRC_IDLE mode operation 341 such as paging channel monitoring and cell reselection and system information acquisition.

UE performs RRC Connection establishment procedure 351 to perform e.g. NAS procedure such as initial registration with the selected PLMN.

After successful RRC connection establishment, UE performs NAS procedure 361 by transmitting a corresponding NAS message via the established RRC connection (e.g. SRB1).

The base station can trigger UE capability reporting procedure 371 before configuring data bearers and various MAC functions.

The base station and the UE perform RRC connection reconfiguration procedure 381. Via the procedure, data radio bearers and logical channels and various MAC functions (such as DRX and BSR and PHR and beam failure reporting etc.) and various RRC functions (such as RRM and RLM and measurement etc.) are configured.

The base station and the UE perform data transfer 391 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is not longer needed for the UE because of e.g. no more traffic available for the UE, the base station and the UE performs RRC connection release procedure 3101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 3111 until the next event to RRC connection establishment/resumption occurs.

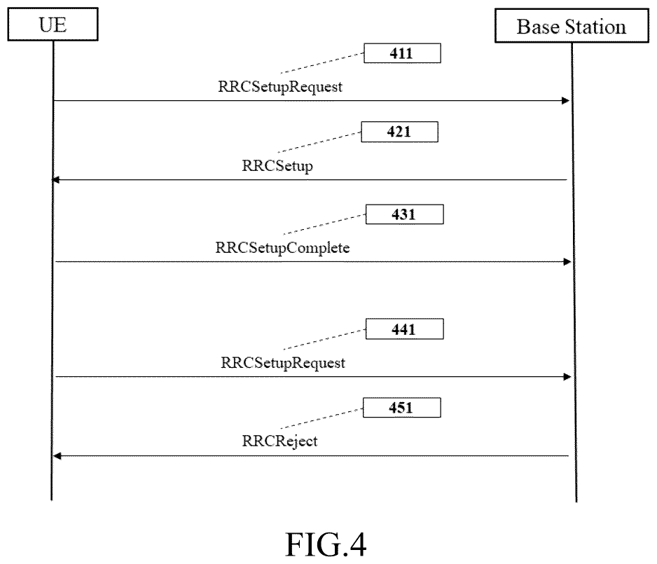

FIG. 4 illustrates RRC connection establishment procedure.

Successful RRC connection establishment procedure comprises:
1: transmission of RRCSetupRequest by the UE 411;
1: reception of RRCSetup by the UE 421;
1: transmission of RRCSetupComplete by the UE 431.

Unsuccessful RRC connection establishment procedure comprises:
1: transmission of RRCSetupRequest by the UE 441;
1: reception of RRCReject by the UE 451;

RRCSetupRequest comprises following fields and IEs:
1: ue-Identity field contains InitialUE-Identity IE which contains:
   2: ng-5G-S-TMSI-Part1 field containing a BIT STRING of 39 bit;
1: establishmentCause field contains EstablishmentCause IE which contains:
   2 enumerated value indicating either emergency, highPriorityAccess, mt-Access, mo-Signalling, mo-Data, mo-VoiceCall, mo-VideoCall, mo-SMS, mps-PriorityAccess, mcs-PriorityAccess etc

RRCSetup comprises following fields and IEs:
1: radioBearerConfig field containing a RadioBearerConfig IE;
1: masterCellGroup field containing a CellGroupConfig IE.

RRCSetupComplete comprises following fields and IEs:
1: selectedPLMN-Identity field containing an integer indicating selected PLMN;
1: dedicatedNAS-Message field containing a DedicatedNAS-Message which may contain various NAS message;
1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identify the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
1: perform the cell group configuration procedure in accordance with the received masterCellGroup;
1: perform the radio bearer configuration procedure in accordance with the received radioBearerConfig;
1: if stored, discard the cell reselection priority information provided by the cellReselectionPriorities or inherited from another RAT;
1: enter RRC_CONNECTED;
1: stop the cell re-selection procedure;
1: consider the current cell to be the PCell;

The UE transmits to the base station RRCSetupComplete after performing above actions.

The UE sets the contents of RRCSetupComplete message as follows:
1: set the ng-5G-S-TMSI-Value to ng-5G-S-TMSI-Part2;
1: set the selectedPLMN-Identity to the PLMN selected by upper layers from the plmn-IdentityInfoList;
1: include the s-NSSAI-List and set the content to the values provided by the upper layers;

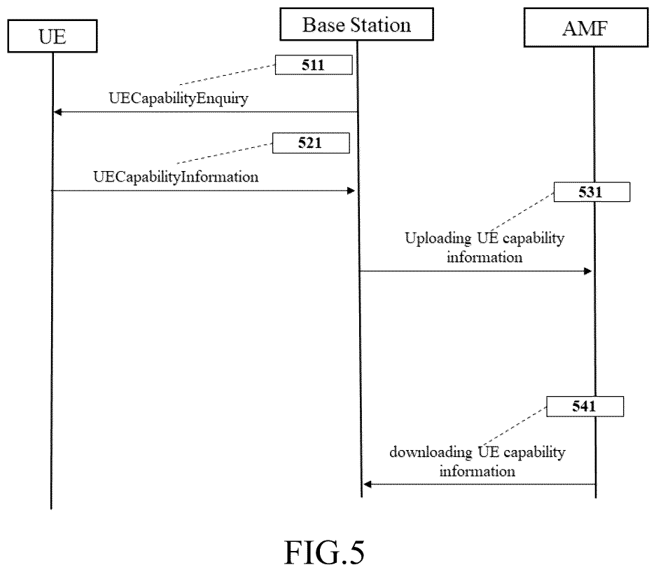

FIG. 5 illustrates UE capability transfer procedure.

For network to configure the UE with appropriate configurations, the network needs to know the capability of the UE. For this end, the UE and the base station perform UE capability transfer procedure.

UE capability transfer procedure consists of exchanging UECapabilityEnquiry 511 and UECapabilityInformation 521 between the UE and the base station.

In the UECapabilityEnquiry, the base station indicates which RAT is subject to capability reporting. UE transmits the capability information for the requested RAT in the UECapabilityInformation.

Once UECapabilityInformation is received, the capability information is uploaded to the AMF by the base station 531. When UE capability information is needed afterward, AMF provides it to the base station 541.

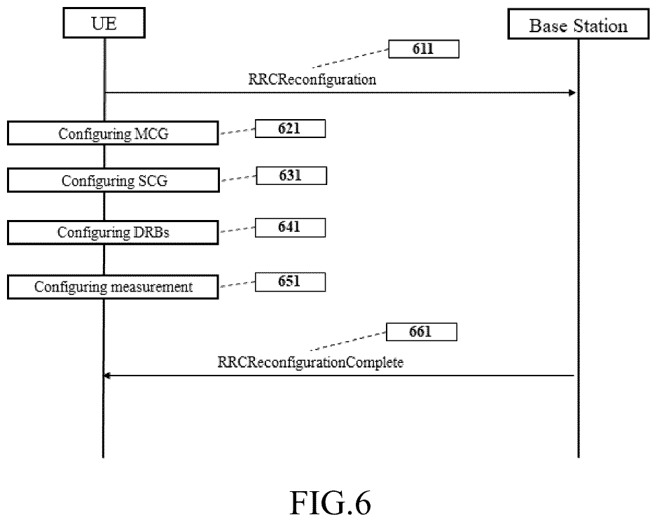

FIG. 6 illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 611 and RRCReconfigurationComplete 661 between the base station and the UE.

RRCReconfiguration may comprise following fields and IEs:
1: rrc-TransactionIdentifier field contains a RRC-TransactionIdentifier IE;
1: radioBearerConfig field contains a RadioBearerConfig IE;
   2: radioBearerConfig field comprises configuration information for SRBs and DRBs via which RRC messages and user traffic are transmitted and received;
1: secondaryCellGroup field contains a CellGroupConfig IE;
   2: secondaryCellGroup field comprises configuration information for secondary cell group;
   2: A cell group consists of a SpCell and zero or more SCells;
   2: Cell group configuration information comprises cell configuration information for SpCell/SCell and configuration information for MAC and configuration information for logical channel etc;
1: measConfig field contains a MeasConfig IE;
   2: measConfig field comprises configuration information for measurements that the UE is required to perform for mobility and other reasons.
1: masterCellGroup field contains a CellGroupConfig IE;

Upon reception of RRCReconfiguration, UE processes the IEs in the order as below. UE may:
1: perform the cell group configuration for MCG based on the received masterCellGroup 621;
1: perform the cell group configuration for SCG based on the received secondaryCellGroup 631;
>1: perform the radio bearer configuration based on the received radioBearerConfig 641;
>1: perform the measurement configuration based on the received measConfig 651;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

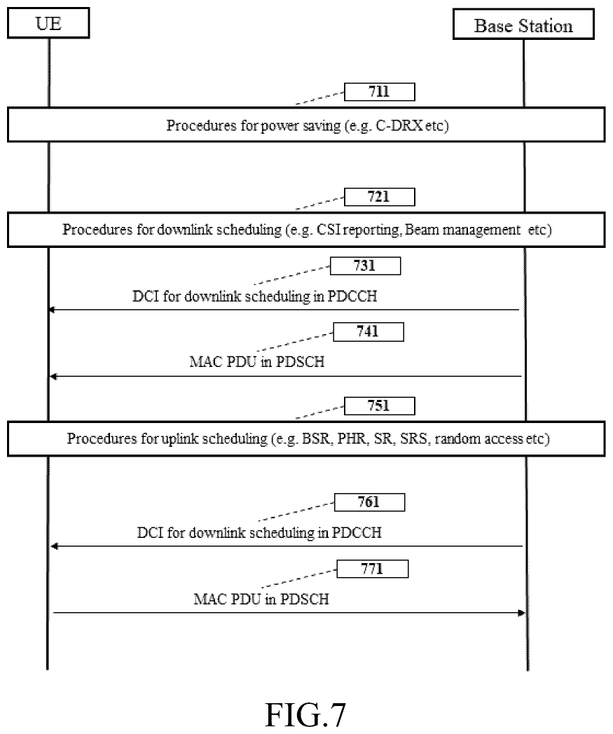

FIG. 7 illustrates data transfer procedure in RRC_CONNECTED state.

The UE and the base station may perform procedures for power saving such as C-DRX 711. The configuration information for C-DRX is provided to the UE within cell group configuration in the RRCReconfiguration.

The UE and the base station may perform various procedures for downlink scheduling 721 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 731. The base station transmits to the UE PDSCH corresponding to the DCI and containing a MAC PDU 741.

The UE and the base station may perform various procedure for uplink scheduling 751 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 761. The base station transmits to the UE PDSCH corresponding to the DCI and containing a MAC PDU 771.

The Synchronization Signal and PBCH block (SSB) 810 consists of primary synchronization signals (PSS) 820 and secondary synchronization signals (SSS) 830. PSS and SSS occupies 1 symbol and 127 subcarriers. PBCH 840 spans across 3 OFDM symbols and 240 subcarriers The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

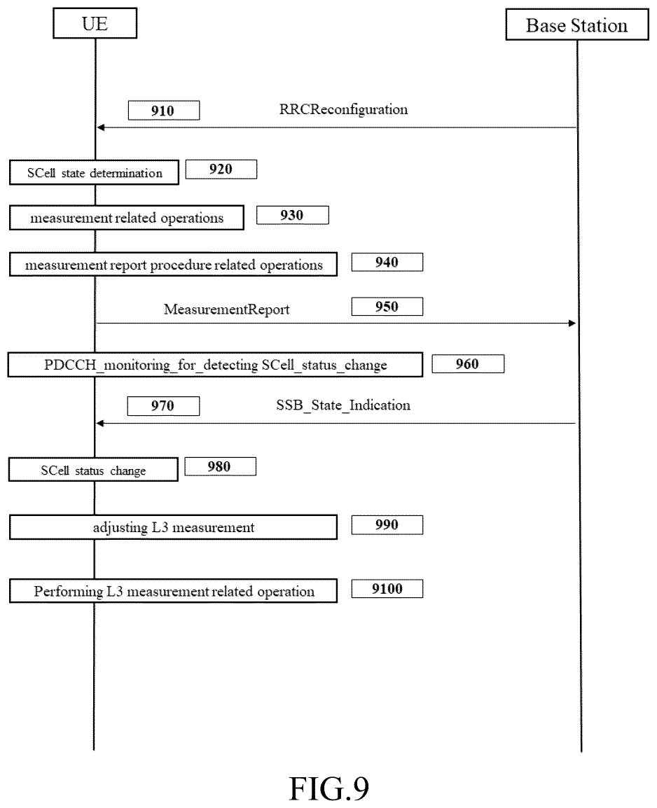

FIG. 9 illustrates the operations for SSB-less SCell that operates demand-driven manner.

In Rel-18 NES, SSB-less SCell operation is limited to the scenario of inter-band CA for FR1 and co-located cells.

In the Rel-18 NES, for SSB-less SCell to work properly, at least one SCell having similar radio characteristics and similar geographical condition is required to transmit SSB continuously. Then UE performs the necessary operation for the SSB-less SCell such as time/frequency synchronization, L1/L3 measurements and SCell activation based on the associated SCell.

One scenario that Rel-18 SSB-less SCell does not cover is when only one FR2 SCell is configured to the UE. Then, since the FR2 SCell does not have associated SCell (having similar radio characteristics and similar geographical condition), FR2 SCell is forced to transmit SSB continuously.

To overcome such restriction, it is necessary to define a new set of operations between the UE and GNBs that enables dynamic turning on> off SSB transmissions.

In the new set of operations, GNB may switch the type/status/state of an SCell.

Table 1 below explains three states of the SCell.

TABLE 1

| | | Deactivated SCell with | Deactivated SCell |
|---|---|---|---|
| | Active SCell | SSB transmission | without SSB transmission |
| | (A-SCell) | (D1-SCell) | (D2-SCell) |
| Characteristics | most power | less power | least power |
| | consuming; and | consuming than A-SCell; | consuming; and |
| | shortest latency | and longer latency | longest latency |
| | for data | for data transmission > | for data |
| | transmission > | reception | transmission > reception |
| | reception. | (SCell activation is | (SCell activation and |
| | | required before data | SSB transmission |
| | | transmission > reception). | activation are required |
| | | | before data |
| | | | transmission > reception). |
| PDCCH | UE monitors PDCCH | UE does not monitor | UE does not monitor |
| | | PDCCH | PDCCH |
| PUSCH/PUCCH/SRS | UE transmit | UE does not transmit | UE does not transmit |
| | PUSCH/PUCCH/SRS | PUSCH/PUCCH/SRS | PUSCH/PUCCH/SRS |
| CSI reporting | UE report CSI | UE does not report CSI | UE does not report CSI |
| CSI measurement | UE measure CSI | UE does not measure | UE does not measure |
| | | CSI | CSI |
| SSB measurement | UE measure SSB with a | UE measures SSB with a | UE does not measure |
| | periodicity determined | periodicity determined | SSB |
| | based on DRX cycle | based on DRX cycle and | |
| | | measCycleSCell | |
| Beam Management | UE performs BM based | UE does not perform BM | UE does not perform BM |
| | on CSI | | |
| L3 RRM | Serving cell | Serving cell | No serving cell |
| measurement | measurement for Al | measurement for Al | measurement for Al |
| | and A2 | and A2 | and A2 |
| | Applicable cell | Applicable cell | Not applicable |
| | for A3 and A5 | for A3 and A5 | cell for A3 and A5 |
| | Measurement results | Measurement results | Measurement results |
| | reported in | reported in | reported in |
| | MeasurementReport | MeasurementReport | MeasurementReport |

Based on traffic load and channel condition of a UE, GNB determines which state to be applied and performs necessary procedure for state transition. The transition is performed between the adjacent states/types (i.e. from A-SCell to D1-SCell or vice versa; from D1-SCell to D2-SCell or vice versa). Transition between A-SCell and D1-SCell is performed based on SCell Activation/Deactivation MAC CE. Transition between D1-SCell and D2-SCell is performed based on DCI 2_10. Transition from D2-SCell to A-SCell can be performed based on SCell Activation>Deactivation MAC CE (if a SCell is activated by the SCell Activation/Deactivation MAC CE and if the SCell is D2-SCell, transition from D2-SCell to A-SCell occurs; UE determines that SSB transmission of the serving cell will start at slot n+m3).

DCI 2_10 causes one or more UEs to change the status of a SCell. SCell A/D MAC CE causes a single UE to change the status of a SCell.

Table 2 summarizes state transitions.

TABLE 2

| State transition | | |
|---|---|---|
| direction | State transition caused by | State transition delay |
| A-SCell → D1-SCell | Reception of A/D MAC CE | When MAC CE is received in slot n, UE start |
| | (the corresponding Ci bit is set | operations related to D1-SCell at slot n + k. |
| | to 0 and the SCell was activated | # k = m + 3# x + 1. |
| | prior to receiving the A/D | # slot n + m is a slot where HARQ-ACK for |
| | MAC CE); or | the MAC CE is indicated. |
| | Expiry of | # x is number of slots per subframe for the |
| | sCellDeactivationTimer | SCS configuration of the PUCCH |
| | associated with SCell | transmission. |
| D1-SCell → A-SCell | Reception of A/D MAC CE | When MAC CE is received in slot n, UE start |
| | (the corresponding Ci bit is set | operations related to A-SCell at slot n + k. |
| | to 1 and the SCell was | # k = m + 3# x + 1. |
| | deactivated prior to receiving | # slot n + m is a slot where HARQ-ACK for |
| | the A/D MAC CE) | the MAC CE is indicated. |
| | | # x is number of slots per subframe for the |
| | | SCS configuration of the PUCCH |
| | | transmission. |
| D1-SCell → D2-SCell | Reception of DCI 2_10 | When DCI 2_10 is received in slot n of |
| | (A specific bit in block whose | serving cell a, UE starts operations related to |
| | block number corresponds to | D2-SCell at slot n + h of serving cell b. |
| | the SCell is set to 0 and the | # h = c + y; |
| | SCell was D1-SCell prior to | # c is a parameter having a different value |
| | receiving DCI 2_10) | depending on a specific SCS. If the specific |
| | | SCS is 15 KHz, a is 1. If 30 KHz, a is 2. If |
| | | 60 KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | | ## Serving cell a is the serving cell where |
| | | DCI 2_10 is received. |
| | | # Serving cell b is the serving cell of which |
| | | status changes based on the received DCI |
| | | 2_10 (e.g. the concerned SCell) is to occur. |
| | | # The specific DL BWP of the serving cell b |
| | | is the BWP indicated by |
| | | firstActiveDownlinkBWP-Id of the serving |
| | | cell b or is initialDownlinkBWP of the |
| | | serving cell b. |
| | | # The specific DL BWP of the serving cell a |
| | | is the BWP where DCI 2_10 is received |
| | | (or DCI 2_10 is configured). |
| | | # y is: |
| | | ## 0 if SCS of the specific DL BWP of the |
| | | serving cell where DCI 2_10 is received and |
| | | SCS of the specific DL BWP of the SCell are |
| | | same; |
| | | ## otherwise, 1. |
| D2-SCell → D1-SCell | Reception of DCI 2_10 | When DCI 2_10 is received in slot n of |
| | (A specific bit in block whose | serving cell a, UE starts operations related to |
| | block number corresponds to | D1-SCell at slot n + h of serving cell b. |
| | the SCell is set to 1 and the | # h = c + y; |
| | SCell was D1-SCell prior to | # c is a parameter having a different value |
| | receiving DCI 2_10) | depending on a specific SCS. If the specific |
| | | SCS is 15 KHz, a is 1. If 30 KHz, a is 2. If |
| | | 60 KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | | ## Serving cell a is the serving cell where |
| | | DCI 2_10 is received. |
| | | # Serving cell b is the serving cell of which |
| | | status changes based on the received DCI |
| | | 2_10 (e.g. the concerned SCell) is to occur. |
| | | # The specific DL BWP of the serving cell b |
| | | is the BWP indicated by |
| | | firstActiveDownlinkBWP-Id of the serving |
| | | cell b or is initialDownlinkBWP of the |
| | | serving cell b. |
| | | # The specific DL BWP of the serving cell a |
| | | is the BWP where DCI 2_10 is received (or |
| | | DCI 2_10 is configured). |
| | | # y is: |
| | | ## 0 if SCS of the specific DL BWP of the |
| | | serving cell where DCI 2_10 is received and |
| | | SCS of the specific DL BWP of the SCell are |
| | | same; |
| | | ## otherwise, 1. |
| D2-SCell → A-SCell | Reception of A/D MAC CE | When MAC CE is received in slot n, UE start |
| | (the corresponding Ci bit is set | operations related to D1-SCell at slot n + k. |
| | to 1 and the SCell was D2- | # k = m + q # x + 1 |
| | SCell prior to receiving the | # slot n + m is a slot where HARQ-ACK for |
| | A/D MAC CE) | the MAC CE is indicated. |
| | | # x is number of slots per subframe for the |
| | | SCS configuration of the PUCCH |
| | | transmission. |
| | | # q is an integer greater than 3. q is fixed in |
| | | the specification and stored in ROM of the UE. |
| A-SCell → D2-SCell | Reception of DCI 2_10 | When DCI 2_10 is received in slot n of |
| | (A specific bit in block whose | serving cell a, UE starts operations related to |
| | block number corresponds to | D2-SCell at slot n + h of serving cell b. |
| | the SCell is set to 0 and the | # h = c + y; |
| | SCell was A-SCell prior to | # c is a parameter having a different value |
| | receiving DCI 2_10) | depending on a specific SCS. If the specific |
| | | SCS is 15 KHz, a is 1. If 30 KHz, a is 2. If |
| | | 60 KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | | ## Serving cell a is the serving cell where |
| | | DCI 2_10 is received. |
| | | # Serving cell b is the serving cell of which |
| | | status changes based on the received DCI |
| | | 2_10 (e.g. the concerned SCell) is to occur. |
| | | # The specific DL BWP of the serving cell b |
| | | is the BWP indicated by |
| | | firstActiveDownlinkBWP-Id of the serving |
| | | cell b or is initialDownlinkBWP of the |
| | | serving cell b. |
| | | # The specific DL BWP of the serving cell a |
| | | is the BWP where DCI 2_10 is received (or |
| | | DCI 2_10 is configured). |
| | | # y is: |
| | | ## 0 if SCS of the specific DL BWP of the |
| | | serving cell where DCI 2_10 is received and |
| | | SCS of the specific DL BWP of the SCell are |
| | | same; |
| | | ## otherwise, 1. |

At 910 UE receives from the GNB a RRCReconfiguration message. The RRCRecofniguration message comprises following fields/IEs.
measConfig field that comprises MeasConfig IE
spCellConfig field that comprises SpCellConfig IE
   newUE-Identity field that comprises RNTI-Value IE (for C-RNTI);
sCellToAddModList field that comprises one or more SCellConfig IEs; Each of SCellConfig may comprises:
   SSB_OFF_INDICATION field that indicates whether the SSB is transmitted in the corresponding SCell;
   positionInDCI_SSB_indication field that indicates the starting position of an information block of DCI format 2_10 (e.g., SSB_State_Indication) for this serving cell;
   valid measurement window field that indicates the time duration related to validity of the measurements taken for SCells that have been changed to D2-SCell recently.
SSB_State_Indication configuration IE;
   cell SSB_RNTI field that comprises RNTI for SSB_State_Indication;
   sizeDCI-2-10 field that indicates the size of SSB_State Indication.

UE configures one or more SCells based on ServingCellConfigCommon IE and ServingCellConfig IE in SCellConifg. UE associates each SCell with a serving cell index. The serving cell index is derived from (or is equal to) SCellIndex IE. UE performs SCell state determination

At 920, UE performs SCell state determination.
For each SCell, UE determines state of each SCells:
   sCellState field is present in the SCellConfig IE, the corresponding SCell is in activated state (A-SCell);
   sCellState field is absent and SSB_OFF_INDICATION field is absent, the corresponding SCell is deactivated state with SSB transmission (D1-SCell);
   sCellState field is absent and SSB_OFF_INDICATION field is present, the corresponding SCell is deactivated state without SSB transmission (D2-SCell).

UE associates each SCell with a MeasObject based on servingCellMO field in the corresponding ServingCellConfig IE. UE configures measurements based on MeasConfig IE.

After performing configurations based on the RRCReconfiguration, UE transmits to the GNB a RRCReconfiguration Complete.

At 930, UE performs measurement related operations. UE may perform serving_cell_measurement_operation for each serving cell. UE determines, through the operation, which to measure and which to not measure.

### <Serving_Cell_Measurement_Operation>

for each serving cell for which servingCellMO is configured, UE performs followings:
   if the serving cell is PCell or A-SCell or D1-SCell;
      UE measure SS/PBCH blocks of the serving cell based on SSB-ToMeasure in the MeasObjectNR IE indicated by corresponding servingCellMO (or based on SSB-ToMeasure in the ServingCellConfigCommon); and
      UE derive layer 3 filtered RSRP and RSRQ per beam for the serving cell based on SS/PBCH block;
   if the serving cell is D2-SCell;
      UE does not measure SS/PBCH blocks of the serving cell;
      UE does not derive layer 3 filtered RSRP and RSRQ per beam for the serving cell.

UE performs evaluation on measurement report triggering. UE may perform, following in the order:
applicable_cell_determination to determine applicable cells and neighbouring cells;
determining_whether_to_perform_measurement_reporting_triggering_evaluation;
measurement_report_triggering_evaluation;
measurement_report_initiating_on_entering or
   measurement_report_initiating_on_leaving or both; and
cellTriggeredList_upadte.

UE performs following for applicable_cell_determination.
For first type event,
   For a measId that is configured with a first type event (alternatively, for each measId, for which the first type event is configured in the corresponding reportConfig):
      UE considers only the serving cell to be applicable for the first type event (alternatively, UE consider a specific SCell to be applicable for the event; the specific SCell is the SCell that is associated with a specific measObject; the specific measObject is associated with a specific reportConfig; the specific reportConfig configures the first type event).
For second type event,
   For a measId that is configured with a second type event (alternatively, for each measId, for which the second type event is configured in the corresponding reportConfig):
      if the concerned measObjectNR (the measObjectNR associated with the measId) is associated with a SCell; and
      if the SCell associated with the measObjectNR is A-SCell or D1-SCell;
         UE considers the SCell to be a neighbouring cell;
         if useAllowedCellList is set to true and if the SCell is included in the allowedCellsToAddModList,
         UE considers the SCell to be applicable.
         if useAllowedCellList is set to true and if the SCell is not included in the allowedCellsToAddModList,
         UE considers the SCell to be not applicable.
         if useAllowedCellList is set to false and if the SCell is not included in the excludedCellsToAddModList,
         UE considers the SCell to be applicable.
         if useAllowedCellList is set to false and if the SCell is included in the excludedCellsToAddModList,
         UE considers the SCell to be not applicable.
      if the SCell associated with the measObjectNR is D2-SCell,
      UE considers the SCell neither neighbouring cell nor to be applicable.
For third type event,
   For a measId that is configured with a third type event (alternatively, for each measId, for which the third type event is configured in the corresponding reportConfig):
      if the concerned measObjectNR (the measObjectNR associated with the measId) is associated with a SCell,
         UE considers the SCell neither neighbouring cell nor to be applicable.

UE performs followings for determining_measurement_report_triggering_evaluation.

### <Determining_Whether_to_Perform_Measurement_Report_Triggering_Evaluation>

For first type event,
   For a measId that is configured with a first type event (alternatively, for each measId, for which the first type event is configured in the corresponding reportConfig):
      if the applicable cell for the first type event is A-SCell or D1-SCell,
         UE determines to performs measurement_reporting_triggering_evaluation for the measId;
      if the applicable cell for the first type event is D2-SCell,
         UE determines to not perform measurement_report_triggering_evaluation for the measId (and determine to perform neither measurement_report_initiating_on_entering nor measurement_report_initiating_on_leaving);
         UE determines to perform measurement_report_triggering_evaluation for the measId when a specific DCI 2_10 is received.
For second type event and third type event,
   For a measId that is configured with a second type event or a third type event:
      UE determines to perform measurement_report_triggering_evaluation for the measId.

UE determines types of events as follows.
First type event is an event that is related only to a specific serving cell.
   The specific serving cell is PCell or SCell that is associated with the corresponding ReportConfig (i.e.ARFCN of the serving cell is same as ARFCN of MeasObjectNR associated with the ReportConfiig #MeasId).
   Only the specific serving cell is applicable.
   Event A1 and Event A2 are first type event.
Second type event is an event that is related to a specific serving cell and one or more neighbouring cells.
   The specific serving cell is PCell.
   The one or more neighbouring cells comprises:
      neighbouring cells detected based on parameters in the associated measObjectNR; and
      SCell associated with the corresponding ReportConfig (i.e.ARFCN of the serving cell is same as ARFCN of MeasObjectNR associated with the ReportConfiig #MeasId).
   Some of the one or more neighbouring cells are applicable.
   Event A3 and Event A5 are second type event
Third type event is an event that is related to only neighbouring cells.
   The one or more neighbouring cells are neighbouring cells detected based on parameters in the associated measObjectNR.
   Some of the one or more neighbouring cells are applicable.
   Event A4 is third type event

UE performs followings for measurement_report_triggering_evaluation.

### <Measurement_Report_Triggering_Evaluation>

For measurement_report_triggering_evaluation for an event (or for a measId associated with the event);
   UE determines to trigger measurement_report_initiating_on_entering if the following conditions are fulfilled.
      the entry condition applicable for this event is fulfilled for one or more applicable cells for all measurements after layer 3 filtering taken during timeToTrigger defined for this event; and
      at least one of the one or more applicable cells is not included in the cells TriggeredList.
   UE determines to trigger measurement_report_initiating_on_leaving if the following conditions are fulfilled.
      the leaving condition applicable for this event is fulfilled for one or more applicable cells for all measurements after layer 3 filtering taken during timeTo Trigger defined for this event; and
      at least one of the one or more applicable cells is included in the cellsTriggeredList.

### <Measurement_Report_Initiating_on_Entering>

For measurement_report_initiating_on_entering for a measId, UE may:
include the measurement reporting entry within the VarMeasReportList for this measId, if not included yet;
include the concerned cell(s) in the cellsTriggeredList defined within the VarMeasReportList for this measId (the concerned cell is the cell that triggered the measurement_report_initiating_on_entering);
if useT312 is set to true in reportConfig for this event:
   if T310 for the corresponding SpCell is running; and
   if T312 is not running for corresponding SpCell:
      start timer T312 for the corresponding SpCell with the value of T312 configured in the corresponding measObjectNR;
initiate the measurement reporting procedure.

### <Measurement_Report_Initiating_on_Leaving>

For measurement_report_initiating_on_leaving for a measId, UE may:
remove the concerned cell(s) in the cellsTriggeredList defined within the VarMeasReportList for this measId (the concerned cell is the cell that triggered the measurement_report_initiating_on_leaving);
if reportOnLeave is set to true for the corresponding reporting configuration
   initiate the measurement reporting procedure, as specified in 5.5.5;
if the cellsTriggeredList defined within the VarMeasReportList for this measId is empty:
   remove the measurement reporting entry within the VarMeasReportList for this measId;

UE performs followings for cellsTriggeredList_update.

For cellsTriggeredList_update for a measId, UE may:
if the entry condition applicable for the event associated with the measId is fulfilled for one or more cells for all measurements after layer3 filtering taken during time ToTriggered; and
if the one or more cells are not included in cellTriggeredList:
   include the one or more cells in the cellsTriggeredList for the MeasId; and
   initiate the measurement reporting procedure;
if the leaving condition applicable for the event associated with the measId is fulfilled for one or more of the cells for all measurements after layer3 filtering taken during timeToTriggered; and
if the one or more cells are included in cellTriggeredList:
   remove the one or more cells in the cellsTriggeredList for the MeasId; and
   initiate the measurement reporting procedure.

UE may remove a specific cell from cellTriggeredList in case that the cell state changes from A-SCell or D1-SCell to D2-SCell (due to reception of SSB_State_Indication). In this case, UE does not initiate the measurement reporting procedure for the MeasId even when the associated ReportConfig is configured with reportOnLeave.

At 940, UE performs measurement report procedure related operations as follows. UE triggers measurement report procedure based on the measurement related operations (e.g. based on determination whether to trigger measurement reporting procedure). Based on the determination, UE performs measurement reporting procedure. For measurement reporting procedure, UE may perform measurement_result_inclusion.

UE performs followings for measurement_result_inclusion through which UE may determine which serving cell's measurement result shall be included in the measurement report message.

<measurement_result_inclusion>
for each serving cell configured with servingCellMO,
   if the serving cell is PCell or A-SCell or D1-SCell,
      include the MeasResultServMO IE of the serving cell in the MeasResultServMOList IE;
   if the serving cell is D2-SCell, and if L3 filtered measurement results for D2-SCell determined within the valid_measurement_window is available (i.e. D2-SCell was D1-SCell at least valid measurement_window before),
      include the corresponding MeasResultServMO IE in the MeasResultServMOList IE,
   if the serving cell is D2-SCell, and if L3 filtered measurement results for D2-SCell
      determined within valid measurement_window is not available;
not include the corresponding MeasResultServMO IE in the MeasResultServMOList IE.

Alternatively,
for each serving cell configured with servingCellMO,
   if the serving cell is PCell or A-SCell or D1-SCell,
      include the type 1_MeasResultServMO IE of the serving cell in the MeasResultServMOList IE;
   if the serving cell is D2-SCell, and if L3 filtered measurement results for D2-SCell determined within valid_measurement_window is available (i.e. D2-SCell was D1-SCell at least valid measurement_window before),
      include the type 1_MeasResultServMO IE in the MeasResultServMOList IE,
   if the serving cell is D2-SCell, and if L3 filtered measurement results for D2-SCell determined within valid measurement_window is not available;
      include the type2_MeasResultServMO IE in the MeasResultServMOList IE. type 1_MeasResultServMO IE comprises followings:
servCellId field that comprises ServCellIndex;
measResultServingCell field that comprises:
   physCellId field that comprises PhysCellId of the serving cell;
   resultsSSB-Cell field or resultsCSI-RS-Cell field that comprises RSRP #RSRQ of the serving cell;
   rsIndexResults field that comprises beam level measurement results of the serving cell;
measResultBestNeighCell field that comprises:
   physCellId field that comprises PhysCellId of the best neighboring cell;
   resultsSSB-Cell field or resultsCSI-RS-Cell field that comprises RSRP #RSRQ of the best neighboring cell;
   rsIndexResults field that comprises beam level measurement results of the best neighboring cell.

type2_MeasResultServMO IE comprises followings:
servCellId field that comprises ServCellIndex;
   measResultServingCell field that comprises:
      physCellId field that comprises PhysCellId of the serving cell;
   measResultBestNeighCell field that comprises:
      physCellId field that comprises PhysCellId of the best neighboring cell;
      resultsSSB-Cell field or resultsCSI-RS-Cell field that comprises RSRP #RSRQ of the best neighboring cell;
      rsIndexResults field that comprises beam level measurement results of the best neighboring cell.

At 950, UE transmits to GNB a MeasurementReport. The MeasurementReport comprises a MeasResultServMOList. GNB may determine to change the states of one or more SCells based on the measurement report. GNB may transmit SSB_State_Indication to change the state of the one or more SCells.

UE performs PDCCH_monitoring_for_detecting SCell_status_change.

UE performs followings for PDCCH_monitoring_for_detecting SCell_status_change.

<PDCCH_monitoring_for_detecting SCell_status_change>
For SSB_State_Indication reception, UE monitors SSB_State_Indication_CSS in one or more specific serving cells based on SSB_State_Indication_RNTI;
   configuration parameters for SSB_State_Indication_CSS is comprised in the SpCellConfig IE;
   the one or more specific serving cells may be:
      a PCell; and
      one or more SCells that is activated and of which active BWP is configured with the SSB_State_Indication_CSS;
For SCell A/D MAC CE reception, UE monitors USS based on C-RNTI in all serving cells that is currently activated;
   configuration parameters for USS is comprised in the SCellConfig IE and in SpCellConfig IE.

At 970, UE receives from GNB SSB_State_Indication. The SSB_State_Indication is carried in DCI format 2_10 or in a MAC CE. SSB_State_Indication indicates, for each cell:
SSB transmission will stop in a specific time point;
SSB transmission will start in a specific time point;
SSB transmission will continue; or
No SSB transmission will continue.

### <DCI Format 2_10>

DCI format 2_10 is used for activating or de-activating the SSB transmission of one or multiple SCells for one or more UEs.

The following information is transmitted by means of the DCI format 2_10 with CRC scrambled by cell_SSB_RNTI:
block number 1, block number 2, . . . , block number N
   the starting position of a block associated with a serving cell is determined by the parameter positionInDCI_SSB_indication provided by higher layers (in a RRCReconfiguration) for the UE.

If the UE is configured to monitor DCI 2_10 with CRC scrambled by cell_SSB_RNTI, one or more blocks are configured for the UE by higher layers (in a RRCReconfiguration), with the following fields defined for each block:
SSB indication—number of bits determined by the following:
   If higher layer parameter positionInDCI_SSB_indication is configured
      1 bit; 0 indicates that SSB transmission is deactivated (no SSB transmission in the corresponding cell); 1 indicates that SSB transmission is activated (SSB is transmitted in the corresponding cell)
      0 bit otherwise.
SSB time offset—number of bits determined by the following:
   If higher layer parameter time_offset_InDCI_SSB_indication is configured
      5 bit; 0 indicates that SSB transmission is activated or deactivated in a predefined time point; 1 indicates that SSB transmission is activated or deactivated in the first SSB transmission occasion after slot n (or symbol n); . . . ; 31 indicates that SSB transmission is activated or deactivated in the 31-th SSB transmission occasion after symbol n; slot n (or symbol n) is the slot (symbol) that the DCI 2_10 is received. The SSB transmission occasion is determined from SSB-ToMeasure in the ServingCellConfigCommon of the SCell.
      0 bit otherwise.

The size of DCI format 2_10 is indicated by the higher layer parameter sizeDCI-2-10.

A block in DCI 2_10 is either a 6 bit or a single bit or a zero bit. Each block is associated with a SCell. The association between the block and the SCell (serving cell) is indicated by the parameter positionInDCI_SSB_indication field in the serving cell configuration information for the SCell. The highest possible value for positionInDCI_SSB_indication is first integer.

A Ci bit in SCell A/D MAC CE is a single bit. Each Ci bit is associated with a SCell. The association between the Ci and the SCell is derived from SCell index. The highest possible value for SCell index is second integer.

The first integer is greater than the second integer because the first integer is related with serving cells of plurality of terminals while the second integer is related with serving cells of a single terminal.

At 980, UE performs, based on DCI 2_10, SCell_status_change_determination. UE determines, for a SCell, whether the SSB transmission in the SCell is activated or deactivated based on received DCI 2_10.

At 990, UE performs, considering the changed status, measurement related operations.
UE may perform serving_cell_measurement_operation_adjusted for each SCell.
UE performs evaluation on measurement report triggering.
   UE performs applicable_cell_determination_after_SCell_status_change to determine applicable cells and neighbouring cells.
   UE performs determining_whether_to_perform measurement_reporting_triggering_evaluation_after_SCell_status_change for measId configured with the first type event.
   UE performs measurement_report_triggering_evaluation.
   UE performs measurement_report_triggering_evaluation.
   UE may perform measurement_report_initiating_on_entering or measurement_report_initiating_on_leaving or both.
   UE may perform cellTriggeredList_upadte.

At 9100, UE performs measurement related operations based on the adjustment.

When UE is configured with one or more SCells (e.g. secondary component carriers), UE may prefer different configurations regarding SCells to achieve power saving or data boosting. If UE is short of battery power, UE may request GNB to change the SCell configurations in such a way that reduce the battery power. If UE expect data boosting will be required in the near future (e.g. when heavy traffic will occur due to high data rate applications such as XR is started), UE may request GNB to change the SCell status in such a way that available bandwidth for data transfer increases.

GNB may configure UE to transmit UAI in such cases. UE may initiate UE Assistance Information.

The purpose of this procedure is for the UE to inform the network of:
its preference on the maximum aggregated bandwidth for power saving, or;
its preference on the maximum number of secondary component carriers for power saving, or;
its preference on the minimum aggregated bandwidth across secondary component carriers for data boosting
its preference on the minimum number of secondary component carriers for data boosting

An example of UEAssistanceInformation is as below.

```
  UEAssistanceInformation ::= SEQUENCE {
      ....
```

| | |
|---|---|
| maxBW-Preference-r16 | MaxBW-Preference-r16 |

```
OPTIONAL,
  //maximum aggregated bandwidth across all downlink carrier(s) and across all uplink
carrier(s) of FR1;
  // maximum aggregated bandwidth across all downlink carrier(s) and across all uplink
carrier(s) of FR2-1; and
  // maximum aggregated bandwidth across all downlink carrier(s) and across all uplink
carrier(s) of FR2-2
```

| | |
|---|---|
| maxCC-Preference-r16 | MaxCC-Preference-r16 |

OPTIONAL,
//maximum number of downlink SCells and uplink SCells

| | |
|---|---|
| minBW-Preference | MinBW-Preference |

OPTIONAL,
//minimum aggregated bandwidth across all downlink secondary carrier(s) and across all
uplink secondary carrier(s) of FR1 and FR2-1 and FR2-2;

| | |
|---|---|
| minCC-Preference | MinCCPreference |

```
OPTIONAL,
  // minimum number of downlink SCells and uplink SCells
    ....
  }
```

| | |
|---|---|
| MaxBW-Preference-r16 ::= | SEQUENCE { |
| reducedMaxBW-FR1-r16 | ReducedMaxBW-FRx-r16 |

OPTIONAL,

| | |
|---|---|
| reducedMaxBW-FR2-r16 | ReducedMaxBW-FRx-r16 |

OPTIONAL
}

| | |
|---|---|
| ReducedMaxBW-FRx-r16 ::= | SEQUENCE { |
| reducedBW-DL-r16 | ReducedAggregatedBandwidth, |
| reducedBW-UL-r16 | ReducedAggregatedBandwidth |

```
  }
  ReducedAggregatedBandwidth ::= ENUMERATED {mhz0, mhz10, mhz20, mhz30,
mhz40, mhz50, mhz60, mhz80, mhz100, mhz200, mhz300, mhz400}
```

| | |
|---|---|
| MinBW ::= | SEQUENCE { |
| minBW-DL | AggregatedBandwidth, |

OPTIONAL

| | |
|---|---|
| minBW-UL | AggregatedBandwidth, |

```
    OPTIONAL
  }
  AggregatedBandwidth ::= ENUMERATED {mhz0, mhz10, mhz20, mhz30, mhz40,
mhz50, mhz60, mhz80, mhz100, mhz200, mhz300, mhz400, mhz400, mhz800, mhz1200,
mhz1600, mhz2000}
```

| | |
|---|---|
| MaxCC-Preference-r16 ::= | SEQUENCE { |
| reducedMaxCCs-r16 | ReducedMaxCCs-r16 |

OPTIONAL
}

| | |
|---|---|
| ReducedMaxCCs-r16 ::= | SEQUENCE { |
| reducedCCsDL-r16 | INTEGER (0..31), |
| reducedCCsUL-r16 | INTEGER (0..31) |

}

| | |
|---|---|
| MinCC-Preference-r16 ::= | SEQUENCE { |
| minCCs | MinCCs |

OPTIONAL
}

| | |
|---|---|
| MinCC ::= | SEQUENCE { |
| minCCsDL | INTEGER (0..31), |
| minCCsUL | INTEGER (0..31) |

}

reducedBW-FR1: This field indicates the UE's preference on reduced configuration corresponding to the maximum aggregated bandwidth across all downlink carrier(s) and across all uplink carrier(s) of FR1, to address overheating or power saving. This field is allowed to be reported only when UE is configured with serving cell(s) operating on FR1. The aggregated bandwidth across all downlink carrier(s) of FR1 is the sum of bandwidth of active downlink BWP(s) across all activated downlink carrier(s) of FR1. The aggregated bandwidth across all uplink carrier(s) of FR1 is the sum of bandwidth of active uplink BWP(s) across all activated uplink carrier(s) of FR1. If the field is absent from the MaxBW-Preference IE or the OverheatingAssistance IE, it is interpreted as the UE having no preference on the maximum aggregated bandwidth of FR1. When indicated to address overheating, this maximum aggregated bandwidth includes carrier(s) of FR1 of both the NR MCG and the SCG. This maximum aggregated bandwidth only includes carriers of FR1 of the SCG in (NG) EN-DC. Value mhz0 is not used when indicated to address overheating. When indicated to address power saving, this maximum aggregated bandwidth includes carrier(s) of FR1 of the cell group that this UE assistance information is associated with. The aggregated bandwidth can only range up to the current active configuration when indicated to address power savings.

reducedBW-FR2: This field indicates the UE's preference on reduced configuration corresponding to the maximum aggregated bandwidth across all downlink carrier(s) and across all uplink carrier(s) of FR2-1, to address overheating or power saving. This field is allowed to be reported only when UE is configured with serving cell(s) operating on FR2-1. The aggregated bandwidth across all downlink carrier(s) of FR2-1 is the sum of bandwidth of active downlink BWP(s) across all activated downlink carrier(s) of FR2-1. The aggregated bandwidth across all uplink carrier(s) of FR2-1 is the sum of bandwidth of active uplink BWP(s) across all activated uplink carrier(s) of FR2-1. If the field is absent from the MaxBW-Preference IE or the OverheatingAssistance IE, it is interpreted as the UE having no preference on the maximum aggregated bandwidth of FR2-1. When indicated to address overheating, this maximum aggregated bandwidth includes carrier(s) of FR2-1 of both the NR MCG and the NR SCG. This maximum aggregated bandwidth only includes carriers of FR2-1 of the SCG in (NG) EN-DC. When indicated to address power saving, this maximum aggregated bandwidth includes carrier(s) of FR2-1 of the cell group that this UE assistance information is associated with. The aggregated bandwidth can only range up to the current active configuration when indicated to address power savings.

minBW: This field indicates the UE's preference on the increased aggregated bandwidth across all downlink secondary carrier(s) and across all uplink secondary carrier(s) of FR1 and FR2-1 and FR2-2. The aggregated bandwidth across all downlink carrier(s) is the sum of bandwidth of active downlink BWP(s) across all activated secondary downlink carrier(s). The aggregated bandwidth across all uplink carrier(s) is the sum of bandwidth of active uplink BWP(s) across all activated secondary uplink carrier(s). If the field is absent from the MinBW-Preference IE, it is interpreted as the UE having no preference on minimum aggregated bandwidth The aggregated bandwidth can only range up to the current configured/deactivated configuration (e.g. bandwidth of D1-SCells and D2-SCells).

reducedCCsDL: This field indicates the UE's preference on reduced configuration corresponding to the maximum number of downlink SCells indicated by the field, to address overheating or power saving. When indicated to address overheating, this maximum number includes both SCells of the NR MCG and PSCell/SCells of the SCG. This maximum number only includes PSCell/SCells of the SCG in (NG) EN-DC. When indicated to address power saving, this maximum number includes PSCell/SCells of the cell group that this UE assistance information is associated with. The maximum number of downlink SCells can only range up to the current active configuration when indicated to address power savings.

reducedCCsUL: This field indicates the UE's preference on reduced configuration corresponding to the maximum number of uplink SCells indicated by the field, to address overheating or power saving. When indicated to address overheating, this maximum number includes both SCells of the NR MCG and PSCell/SCells of the SCG. This maximum number only includes PSCell/SCells of the SCG in (NG) EN-DC. When indicated to address power saving, this maximum number includes PSCell/SCells of the cell group that this UE assistance information is associated with. The maximum number of uplink SCells can only range up to the current active configuration when indicated to address power savings.

minCCsDL: This field indicates the UE's preference on number of downlink SCells. This number includes both SCells of the NR MCG and PSCell/SCells of the SCG. This maximum number only includes PSCell/SCells of the SCG in (NG) EN-DC. The number of downlink SCells can only range up to the current configuration (e.g. configured SCells; PSCell, A-SCell(s), DI-SCell(s) and D2-SCell(s)).

minCCsUL: This field indicates the UE's preference on increased number of uplink SCells. This number includes both SCells of the NR MCG and PSCell/SCells of the SCG. This minimum number only includes PSCell/SCells of the SCG in (NG) EN-DC. The number of uplink SCells can only range up to the current configuration (e.g. configured SCells; A-SCell(s), DI-SCell(s) and D2-SCell(s)).

To request GNB to change the SCell status in such a way that available bandwidth for data transfer increases, UE performs Initiation_UEAssistanceInformation and Transmission_UEAssistance Information.

### <Initiation_UEAssistaneceInformation>

if configured to provide its preference on the maximum aggregated bandwidth of a cell group for power saving and T346b is not running:
   if the UE has a preference on the maximum aggregated bandwidth of the cell group and the UE did not transmit a UEAssistanceInformation message with maxBW-Preference and/or maxBW-PreferenceFR2-2 for the cell group since it was configured to provide its preference on the maximum aggregated bandwidth of the cell group for power saving; or
   if the current maxBW-Preference information for the cell group is different from the one indicated in the last transmission of the UEAssistanceInformation message including maxBW-Preference and/or maxBW-PreferenceFR2-2 for the cell group and timer T346b associated with the cell group is not running:
      start the timer T346b with the timer value set to the maxBW-PreferenceProhibitTimer of the cell group;
      initiate transmission of the UEAssistanceInformation message in accordance with 5.7.4.3 to provide the current maxBW-Preference and/or maxBW-PreferenceFR2-2;
if configured to provide its preference on the maximum number of secondary component carriers of a cell group for power saving and T346c is not running:
   if the UE has a preference on the maximum number of secondary component carriers of the cell group and the UE did not transmit a UEAssistanceInformation message with maxCC-Preference for the cell group since it was configured to provide its preference on the maximum number of secondary component carriers of the cell group for power saving; or
   if the current maxCC-Preference information for the cell group is different from the one indicated in the last transmission of the UEAssistanceInformation message including maxCC-Preference for the cell group and timer T346c associated with the cell group is not running:
      start the timer T346c with the timer value set to the maxCC-PreferenceProhibitTimer of the cell group;
      initiate transmission of the UEAssistance Information message in accordance with 5.7.4.3 to provide the current maxCC-Preference;
if configured to provide its preference on the minimum aggregated SCell bandwidth of a cell group for data boosting (higher data rate; bulk data transfer) and T346q is not running:
   if the UE has a preference on the aggregated SCell bandwidth of the cell group and the UE did not transmit a UEAssistanceInformation message with minBW-Preference for the cell group since it was configured to provide its preference on the maximum aggregated bandwidth of the cell group for power saving; or
   if the current minBW-Preference information for the cell group is different from the one indicated in the last transmission of the UEAssistanceInformation message including minBW-Preference for the cell group and timer T346q associated with the cell group is not running:
      start the timer T346q with the timer value set to the minBW-PreferenceProhibitTimer (indicated in RRCReconfiguration generated by the base station o the cell group) of the cell group;
      initiate transmission of the UEAssistanceInformation message in accordance with 5.7.4.3 to provide the current minBW-Preference;
if configured to provide its preference on the number of secondary component carriers of a cell group for data boosting and T346p is not running:
   if the UE has a preference on the number of secondary component carriers of the cell group and the UE did not transmit a UEAssistanceInformation message with MinCC-Preference for the cell group since it was configured to provide its preference on the number of secondary component carriers of the cell group for data boosting; or
   if the current MinCC-Preference information for the cell group is different from the one indicated in the last transmission of the UEAssistanceInformation message including MinCC-Preference for the cell group and timer T346r associated with the cell group is not running:
      start the timer T346p with the timer value set to the MinCC-PreferenceProhibitTimer (indicated in RRCReconfiguration generated by the base station o the cell group) of the cell group;
      initiate transmission of the UEAssistanceInformation message in accordance with 5.7.4.3 to provide the current MinCC-Preference;

### <Transmission_UEAssistaneceInformation>

if transmission of the UEAssistanceInformation message is initiated to provide maxBW-Preference of a cell group for power saving:
   include maxBW-Preference in the UEAssistanceInformation message;
   if the UE has a preference on the maximum aggregated bandwidth for the cell group:
      if the UE prefers to reduce the maximum aggregated bandwidth of FR1:
         include reducedMaxBW-FR1 in the MaxBW-Preference IE;
         set reducedBW-DL to the maximum aggregated bandwidth the UE desires to have configured across all downlink carriers of FR1 in the cell group;
         set reducedBW-UL to the maximum aggregated bandwidth the UE desires to have configured across all uplink carriers of FR1 in the cell group;
      if the UE prefers to reduce the maximum aggregated bandwidth of FR2-1:
         include reducedMaxBW-FR2 in the MaxBW-Preference IE;
         set reducedBW-DL to the maximum aggregated bandwidth the UE desires to have configured across all downlink carriers of FR2-1 in the cell group;
         set reducedBW-UL to the maximum aggregated bandwidth the UE desires to have configured across all uplink carriers of FR2-1 in the cell group;
   else (if the UE has no preference on the maximum aggregated bandwidth for the cell group):
      do not include reducedMaxBW-FR1 and reducedMaxBW-FR2 in the MaxBW-Preference IE;
if transmission of the UEAssistanceInformation message is initiated to provide maxBW-PreferenceFR2-2 of a cell group for power saving:
   include maxBW-PreferenceFR2-2 in the UEAssistanceInformation message;
      if the UE prefers to reduce the maximum aggregated bandwidth of FR2-2:
         include reducedMaxBW-FR2-2 in the MaxBW-PreferenceFR2-2 IE;
         set reducedBW-FR2-2-DL to the maximum aggregated bandwidth the UE desires to have configured across all downlink carriers of FR2-2 in the cell group;
         set reducedBW-FR2-2-UL to the maximum aggregated bandwidth the UE desires to have configured across all uplink carriers of FR2-2 in the cell group;
   else (if the UE has no preference on the maximum aggregated bandwidth for the cell group):
      do not include reducedMaxBW-FR2-2 in the MaxBW-PreferenceFR2-2 IE;
if transmission of the UEAssistanceInformation message is initiated to provide minBW-Preference of a cell group for data boosting:
   include minBW-Preference in the UEAssistanceInformation message;
   if the UE has a preference on the aggregated bandwidth for the cell group:
      include MinBW in the minBW-Preference IE;
      set minBW-DL to the aggregated bandwidth the UE desires to have configured across all downlink secondary carriers of FR1 and FR2-1 and FR2-2 in the cell group;
      set minBW-UL to the aggregated bandwidth the UE desires to have configured across all uplink secondary carriers of FR1 and FR2-1 and FR2-2 in the cell group;
   else (if the UE has no preference on the aggregated bandwidth for the cell group):
      do not include minBW-DL and minBW-UL in the MinBW-Preference IE;
if transmission of the UEAssistanceInformation message is initiated to provide maxCC-Preference of a cell group for power saving:
   include maxCC-Preference in the UEAssistanceInformation message;
   if the UE has a preference on the maximum number of secondary component carriers for the cell group:
      include reducedMaxCCs in the MaxCC-Preference IE;
      set reducedCCsDL to the number of maximum SCells the UE desires to have configured in downlink in the cell group;
      set reducedCCsUL to the number of maximum SCells the UE desires to have configured in uplink in the cell group;
   else (if the UE has no preference on the maximum number of secondary component carriers for the cell group):
      do not include reducedMaxCCs in the MaxCC-Preference IE;
if transmission of the UEAssistanceInformation message is initiated to provide sccNR-Preference of a cell group for data boosting:
   include SccNR-Preference in the UEAssistanceInformation message;
   if the UE has a preference on the number of activated secondary component carriers for the cell group:
      include MinCC in the MinCC-Preference IE;
      set minCCsDL to the number of activated SCells the UE desires to have activated in downlink in the cell group;
      set minCCsUL to the number of activated SCells the UE desires to have activated in uplink in the cell group;
   else (if the UE has no preference on the number of activated secondary component carriers for the cell group):
      do not include minCC in the MinCC-Preference IE;

The UE shall:
if the UE is in (NG) EN-DC:
   if SRB3 is configured and the SCG is not deactivated:
      submit the UEAssistanceInformation message via SRB3 to lower layers for transmission;
   else:
      submit the UEAssistanceInformation message via the E-UTRA MCG embedded in E-UTRA RRC message ULInformationTransferMRDC.
else if the UE is in NR-DC:
   if the UE assistance configuration that triggered this UE assistance information is associated with the SCG:
      if SRB3 is configured and the SCG is not deactivated:
         submit the UEAssistanceInformation message via SRB3 to lower layers for transmission;
      else:
         submit the UEAssistanceInformation message via the NR MCG embedded in NR RRC message ULInformationTransferMRDC;
   else:
      submit the UEAssistanceInformation message via SRB1 to lower layers for transmission;
else:
   submit the UEAssistanceInformation message to lower layers for transmission.

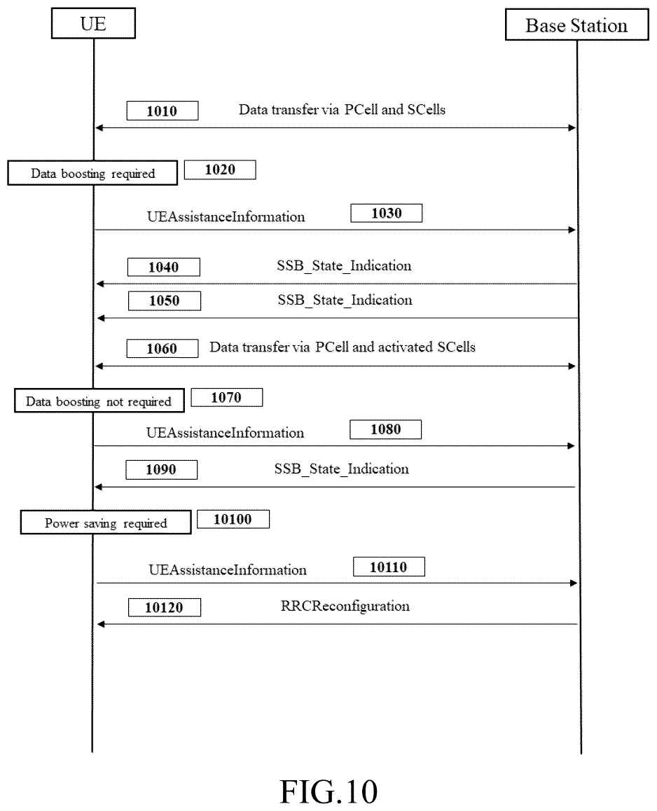

FIG. 10 illustrates the operation between the terminal and base station for UEAssistanceInformaiton for power saving or for data boosting.

UE and GNB perform data transfer via PCell and activated SCells 1010.

UE determines that data boosting is required based on that data heavy application is initiated 1020. UE may perform initiation_UEAssistanceInformation to determine whether to transmit UEAssistanceInformation. UE may perform transmission_UEAssistanceInformation if determined so.

UE transmits UEAssistanceInformation 1030. The UEAssistanceInformation includes the preference on the minimum aggregated bandwith of active BWP or minimum number of activated SCCs for data boosting.

GNB takes proper measures to accommodate the UE's preference for data boosting. GNB may transmits SSB_State_Indication to activate SSB transmission of SCells (e.g. to cause state transition from D2-SCell to D1-SCell) 1040 and SCell A/D MAC CE to activated the SCells 1050.

UE and GNB perform data transfer via PCell and activated SCells 1060. Comparing to 1010, the number of activated SCells and the total aggregated bandwidth of active BWP are increased.

UE determines that data boosting is not required based on that data heavy application is terminated 1070. UE may perform initiation_UEAssistanceInformation to determine whether to transmit UEAssistanceInformation. UE may perform transmission_UEAssistanceInformation if determined so.

UE transmits UEAssistanceInformation 1080. The UEAssistance Information includes MinBW-Preference IE that contains neither minBW-DL nor minBW-UL if the previous UEAssistanceInformation included MinBW-Preference IE. The UEAssistanceInformation includes SccNR-Preference IE that does not contain minCC if the previous UEAssistance Information included SccNR-Preference IE.

GNB takes proper measures to achieve network power saving. GNB may transmit SSB_State_Indication to deactivate SSB transmission of SCells (e.g. to cause state transition from D1-SCell/A-SCell to D2-SCell) 1090.

UE determines that power saving is required based on that residual battery power is below a certain threshold 10100. UE may perform initiation_UEAssistanceInformation to determine whether to transmit UEAssistanceInformation. UE may perform transmission UEAssistanceInformation if determined so.

UE transmits UEAssistanceInformation 10110. The UEAssistanceInformation includes the preference on the maximum aggregated bandwith of active BWP or maximum number of SCCs for power saving.

GNB takes proper measures to accommodate the UE's preference. GNB may transmits RRCReconfiguration to reduce the aggregate bandwidth or number of SCCs 10120.

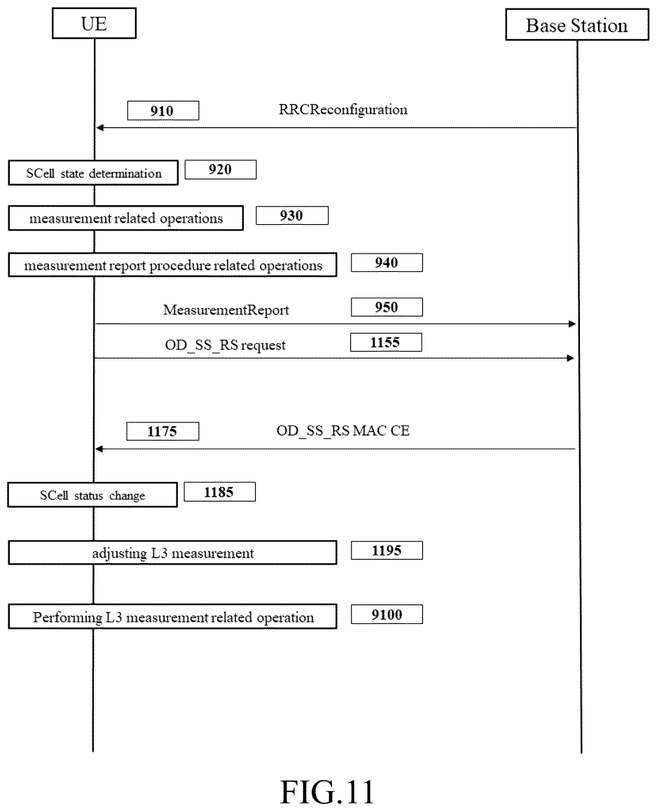

FIG. 11 illustrates operations of UE and base station for on-demand SSB.

Followings may be used interchangeably:
OD-SS-RS and SS/RS;
SS/RS and SS-RS and SS and SSB (e.g. the procedure/message/operation for SS/RS are also applicable when SSB is used instead of SS/RS) and specific signal block;
sparse SS-RS and normal SS-RS and periodic SS-RS and always-on SS-RS;
enabled and activated;
OD-SSB activation/deactivation information and DCI 2_10 and OD_SS_RS MAC CE.
   <SS-RS burst>

A set of specific signal blocks (SS-RS burst) is transmitted in a SCell during a half frame. For periodic SS-RS, the half frame occurs periodically with periodicity indicated by ssb-periodicityServingCell once it is configured. For OD-SS-RS, the half frame occurs periodically with periodicity indicated by ssb-periodicityServingCell2 once it is enabled.

For a half frame with specific signal blocks, the first symbol indexes for candidate specific signal blocks are determined according to the SCS of specific signal blocks as follows, where index 0 corresponds to the first symbol of the first slot in a half-frame.
Case A—15 kHz SCS: the first symbols of the candidate specific signal blocks have indexes of {2,8}+14·n
   For operation without shared spectrum channel access:
      For carrier frequencies smaller than or equal to 3 GHZ, n=0,1.
      For carrier frequencies within FR1 larger than 3 GHZ, n=0, 1, 2, 3.
   For operation with shared spectrum channel access, as described in [15, TS 37.213], n=0, 1, 2, 3, 4.
Case B—30 kHz SCS: the first symbols of the candidate specific signal blocks have indexes {4,8,16,20}+28·n. For carrier frequencies smaller than or equal to 3 GHz, n=0. For carrier frequencies within FR1 larger than 3 GHz, n=0,1.
Case C—30 kHz SCS: the first symbols of the candidate specific signal blocks have indexes {2,8}+14.n.
   For operation without shared spectrum channel access
      For paired spectrum operation
         For carrier frequencies smaller than or equal to 3 GHZ, n=0,1. For carrier frequencies within FR1 larger than 3 GHZ, n=0, 1, 2, 3.
      For unpaired spectrum operation
         For carrier frequencies smaller than 1.88 GHZ, n=0,1. For carrier frequencies within FR1 equal to or larger than 1.88 GHz, n=0, 1, 2, 3.
   For operation with shared spectrum channel access, n=0, 1, 2, 3, 4, 5, 6, 7, 8, 9.
Case D—120 kHz SCS: the first symbols of the candidate specific signal blocks have indexes {4,8,16,20}+28.n. For carrier frequencies within FR2 and FR2-NTN, n=0, 1, 2, 3, 5, 6, 7, 8, 10, 11, 12, 13, 15, 16, 17, 18.
Case E—240 kHz SCS: the first symbols of the candidate specific signal blocks have indexes {8,12,16,20,32,36,40,44}+56·n. For carrier frequencies within FR2-1 and FR2-NTN, n=0, 1, 2, 3, 5, 6, 7, 8.
Case F—480 kHz SCS: the first symbols of the candidate specific signal blocks have indexes {2,9}+14.n. For carrier frequencies within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31.
Case G—960 kHz SCS: the first symbols of the candidate specific signal blocks have indexes {2,9}+14.n. For carrier frequencies within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31.

The candidate specific signal blocks in a half frame are indexed in an ascending order in time from 0 to ⁻L_max−1, where ⁻L_max is determined according to SS/PBCH block patterns for Cases A through G. L_max is a maximum number of SS/PBCH block indexes in a cell, and the maximum number of transmitted specific signal blocks within a half frame is L max.
For operation without shared spectrum channel access in FR1 and FR2, and for operation with shared spectrum channel access in FR2-2, ⁻L_max=L max
For operation with shared spectrum channel access in FR1, L_max=8 for ⁻L_max=10 and 15 kHz SCS of specific signal blocks and for ⁻L_max=20 and 30 kHz SCS of specific signal blocks

A UE can be provided per serving cell by ssb-periodicityServingCell a periodicity of the half frames for reception of the sparse specific signal blocks for the serving cell. If the UE is not configured a periodicity of the half frames for receptions of the sparse specific signal blocks, the UE assumes a periodicity of a half frame. A UE assumes that the periodicity is same for all specific signal blocks in the serving cell.

A UE can be provided per serving cell by ssb-periodicityServingCell2 a periodicity of the half frames for reception of the on demand specific signal blocks for the serving cell. If the UE is not configured a periodicity of the half frames for receptions of the on-demand specific signal blocks, the UE assumes the serving cell does not support on-demand specific signal block.

At 910 UE receives from the GNB a RRCReconfiguration message. The message may comprise following IE.

```
  # OD_SS_RS-RequestConfig that comprises configuration information for OD_SS_RS
request per SCells; and
  # sCellToAddModList field that comprises one or more SCellConfig IEs.
```

| | |
|---|---|
| SCellConfig ::= | SEQUENCE { |
| sCellIndex | SCellIndex, |
| sCellConfigCommon | ServingCellConfigCommon |

OPTIONAL, -- Cond SCellAdd

| | |
|---|---|
| sCellConfigDedicated | ServingCellConfig |

```
OPTIONAL, -- Cond SCellAddMod
      ...,
      [[
```

| | |
|---|---|
| smtc | SSB-MTC |

OPTIONAL -- Need S

| | |
|---|---|
| smtc2 | SSB-MTC |

```
OPTIONAL -- Need S
        ]],
      [[
```

| | |
|---|---|
| sCellState-r16 | ENUMERATED {activated} |

OPTIONAL, -- Cond SCellAddSync

| | |
|---|---|
| sCellState-r18 | ENUMERATED {SSB-OFF} |

OPTIONAL,

| | |
|---|---|
| sCellStateUponDeactivation-r18 | ENUMERATED {SSB-OFF} |

OPTIONAL,

| | |
|---|---|
| secondaryDRX-GroupConfig-r16 | ENUMERATED {true} |

```
OPTIONAL -- Need S
      ]],
      [[
```

| | |
|---|---|
| preConfGapStatus-r17 | BIT STRING (SIZE (maxNrofGapId-r17)) |

OPTIONAL, -- Cond PreConfigMG
goodServingCellEvaluationBFD-r17 GoodServingCellEvaluation-r17
OPTIONAL, -- Need R

| | |
|---|---|
| sCellSIB20-r17 | SetupRelease { SCellSIB20-r17 } |

```
OPTIONAL -- Need M
      ]],
      [[
```

| | |
|---|---|
| plmn-IdentityInfoList-r17 | SetupRelease {PLMN-IdentityInfoList} |

OPTIONAL, -- Cond SCellSIB20-Opt

| | |
|---|---|
| npn-IdentityInfoList-r17 | SetupRelease {NPN-IdentityInfoList-r16} |

```
OPTIONAL -- Cond SCellSIB20-Opt
      ]]
  }
```

SCellState-r16 field indicates whether the SCell shall be considered to be in activated state upon SCell configuration. If this field is absent, the SCell shall be considered to be in deactivated state upon SCell configuration.

SCellState-r18 field indicates whether SSB transmission is disabled in the SCell when SCell configuration is received. If this field is absent, the SSB shall be considered being transmitted in the SCell when SCell configuration is received.

TABLE 3

| SCellState- | SCellState- | |
|---|---|---|
| r16 | r18 | Description |
| Present | Present | Not valid; UE ignore SCellConfig. |
| Present | Absent | The SCell is activated (e.g. A-SCell). |
| Absent | Present | The SCell is deactivated; SSB transmission |
| | | is disabled (e.g. D2-SCell). |
| Absent | Absent | The SCell is deactivated; SSB transmission |
| | | is enabled (e.g. D1-SCell). |

SCellStateUponDeactivation-r18 field indicates whether SSB transmission is disabled in the SCell when SCell is deactivated after being activated (e.g. due to expiry of SCell. If this field is absent, the SSB shall be considered being transmitted in the SCell when SCell configuration is received.

In CASE #1 (only OD-SS-RS), smtc field indicates the OD-SS-RS periodicity/offset/duration configuration of the SCell. If the field is absent and absolute FrequencySSB is included, the UE uses the SMTC in the measObjectNR having the same SSB frequency and subcarrier spacing, as configured before the reception of the RRC message. In case that the SCell is either A-SCell or D1-SCell, SMTC is valid upon SCell configuration. In case that the SCell is D2-SCell, SMTC is invalid upon SCell configuration until SSB transmission is enabled. SMTC is valid upon receiving a MAC CE that enables OD-SS-RS transmission.

In CASE #2 (OD-SS-RS+sparse SS-RS), smtc field comprises parameter for the sparse SS-RS (SS-RSs that are periodically transmitted) and smtc2 field comprises parameter for the OD-SS-RS. smtc is valid when it is configured, smtc2 is valid when it is configured and OD-SS-RS transmission is enabled for the SCell.

| | |
|---|---|
| SSB-MTC ::= | SEQUENCE { |
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159) |

},

| | |
|---|---|
| duration | ENUMERATED { sf1, sf2, sf3, sf4, |

sf5 }
}

Duration field indicates duration of the measurement window in which to receive SS/PBCH blocks. It is given in number of subframes.

periodicityAndOffset field indicates periodicity and offset of the measurement window in which to receive SS/PBCH blocks. Periodicity and offset are given in number of subframes.

| | |
|---|---|
| ServingCellConfigCommon ::= | SEQUENCE { |
| physCellId | PhysCellId |

OPTIONAL, -- Cond HOAndServCellAdd,

| | |
|---|---|
| downlinkConfigCommon | DownlinkConfigCommon |

OPTIONAL, -- Cond HOAndServCellAdd

| | |
|---|---|
| uplinkConfigCommon | UplinkConfigCommon |

OPTIONAL, -- Need M

| | |
|---|---|
| supplementaryUplinkConfig | UplinkConfigCommon |

OPTIONAL, -- Need S

| | |
|---|---|
| n-TimingAdvanceOffset | Enumerated { n0, n25600, n39936 } |

OPTIONAL, -- Need S

| | |
|---|---|
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |

}
OPTIONAL, -- Cond AbsFreqSSB

| | |
|---|---|
| ssb-periodicityServingCell | ENUMERATED { ms5, ms10, ms20, ms40, |
| ms80, ms160, spare2, spare1 } | OPTIONAL, -- Need S |
| ssb-periodicityServingCell2 | ENUMERATED { ms5, ms10, ms20, ms40, ms80, |
| ms160, spare2, spare1 } | OPTIONAL, -- Need S |
| dmrs-TypeA-Position | ENUMERATED {pos2, pos3}, |
| lte-CRS-ToMatchAround | SetupRelease { RateMatchPatternLTE- |
| CRS } | OPTIONAL, -- Need M |
| rateMatchPatternToAddModList | SEQUENCE (SIZE |
| (1..maxNrofRateMatchPatterns)) OF RateMatchPattern | OPTIONAL, -- Need N |
| rateMatchPatternToReleaseList | SEQUENCE (SIZE |
| (1..maxNrofRateMatchPatterns)) OF RateMatchPatternID | OPTIONAL, -- Need N |
| ssbSubcarrierSpacing | SubcarrierSpacing |

OPTIONAL, -- Cond HOAndServCellWithSSB

| | |
|---|---|
| tdd-UL-DL-ConfigurationCommon | TDD-UL-DL-ConfigCommon |

OPTIONAL, -- Cond TDD

| | |
|---|---|
| ss-PBCH-BlockPower | INTEGER (−60..50), |
| ss-PBCH-BlockPower2 | INTEGER (−60..50), |
| SS_RS_Type | ENUMERATED |

{SS, SS/RS}
[[

Specific signal block is SS/PBCH block (PSS/SSS/PBCH DM-RS/PBCH) in case that the SCell is legacy SCell (e.g. SS_RS_Type is absent).

Specific signal block is PSS/SSS in case that the SCell is type1 SCell (e.g. SS_RS_Type is set to SS).

Specific signal block is PSS/SSS/PBCH DM-RS in case that the SCell is type1 SCell (e.g. SS_RS_Type is set to SS/RS).

When specific signal block is SSB, following parameters are valid when they are configured.

downlinkConfigCommon indicates the common downlink configuration of the serving cell, including the frequency information configuration and the initial downlink BWP common configuration.

longBitmap is a bitmap when maximum number of specific signal blocks per half frame equals to 64.

mediumBitmap is a bitmap when maximum number of specific signal blocks per half frame equals to 8.

n-TimingAdvance Offset indicates the N_TA-Offset to be applied for all uplink transmissions on this serving cell if n-TimingAdvanceOffset2 is not configured.

shortBitmap is a bitmap when maximum number of specific signal blocks per half frame equals to 4.

In type #1, ss-PBCH-BlockPower indicates average EPRE of the resources elements that carry secondary synchronization signals in dBm that the NW used for specific signal block transmission. It is used both for OD-SS-RS and sparse SS-RS.

In type #2, ss-PBCH-BlockPower2 indicates average EPRE of the resources elements that carry secondary synchronization signals in dBm that the NW used for OD-SS-RS transmission. It is used for OD-SS-RS only and valid when OD-SS-RS transmission is enabled for the SCell. ss-PBCH-BlockPower is valid for sparse OD-SS-RS only and valid when it is configured.

In type #1, ssb-periodicityServingCell indicates the OD-SS-RS periodicity in ms for the rate matching purpose. If the field is absent, the UE applies the value ms5. This field is used only when OD-SS-RS transmission is enabled.

ssb-PositionQCL indicates the QCL relation between specific signal block positions for this serving cell. It is used both for OD-SS-RS and sparse SS-RS.

ssb-PositionsInBurst indicates the time domain positions of the transmitted SS-blocks in a half frame with specific signal blocks. The first/leftmost bit corresponds to specific signal block index 0, the second bit corresponds to specific signal block index 1, and so on. Value 0 in the bitmap indicates that the corresponding specific signal block is not transmitted while value 1 indicates that the corresponding specific signal block is transmitted. It is used both for OD-SS-RS and sparse SS-RS.

ssbSubcarrierSpacing indicates Subcarrier spacing of specific signal block. It is used both for OD-SS-RS and sparse SS-RS.

tdd-UL-DL-ConfigurationCommon indicates a cell-specific TDD UL/DL configuration.

SS_RS_Type indicates whether SS-RS is PSS/SSS or PSS/SSS/PBCH DM-RS.

UE configures one or more SCells based on ServingCellConfigCommon IE and ServingCellConfig IE in SCellConifg. UE associates each SCell with a serving cell index. The serving cell index is derived from (or is equal to) SCellIndex IE. UE performs SCell state determination

At 920, UE performs SCell state determination. In addition, UE associates each SCell with a MeasObject based on servingCellMO field in the corresponding ServingCellConfig IE.

At 930, UE performs measurement related operations.

At 940, UE performs measurement report procedure related operations.

At 950, UE transmits to GNB a MeasurementReport.

At 1155, UE may transmit OD_SS_RS request.

If UE determines D2-SCell needs to be activated, UE performs OD_SS_RS_REQUEST.

UE may perform, based on SIB1 of the first cell, SI_REQEUST in a first cell to acquire/request OSI of the first cell.

UE may perform, based on SIB X of the first cell, MSI_REQUEST in a second cell to acquire/requet SIB1 of the second cell.

UE may perform, based on configuration informaton of the first cell, OD_SS_RS_REQUEST in the first cell to acquire/reqeust SSB (excluding MIB) of the second cell.

First cell is a serving cell related to RRC connection establishment procedure. Second cell is a cell that is not the first cell.

At 1175, GNB transmits to the UE a OD_SS_RS MAC CE to enable SSB transmission.

OD_SS_RS MAC CE (1210) comprises following fields.
SCellIndex field (3 bit): This field comprises an identifier that is derived from ServCellIndex of the SCell.
A/D field (1 bit): This field indicates whether OD_SS_RS transmission is activated or deactivated.
Activation Time field (4 bit): This field comprises 4 LSBs of SFN of the PCell where OD SS RS transmission in the SCell may start.
Transmission number field (8 bit): This field indicates the number of OD_SS_RS burst transmission. Each OD_SS_RS burst comprises one or more OD_SS RSs.
Transmission periodicity field (8 bit): This field indicates the periodicity of OD_SS_RS burst transmission.

Activation Time field and Transmission number field and Transmission periodicity field are present in case that A/D field is set to 1 (indicating OD_SS_RS transmission is activated).

Activation Time field and Transmission number field and Transmission periodicity field are absent in case that A/D field is set to 0 (indicating OD_SS_RS transmission is deactivated).

At 1185, UE performs, based on OD_SS_RS MAC CE, SCell_status_change_determination. UE determines, for a SCell, whether the OD_SS_RS transmission in the SCell is activated or deactivated based on received OD_SS_RS MAC CE. UE performs, for a SCell, beam_failure_operation if the A-SCell is deactivated to D2-SCell due to reception of received OD_SS_RS MAC CE.

### <Beam_Failure_Operation>

If a OD_SS RS MAC CE is received at slot n of a first cell (one of one or more specific serving cells) and the OD_SS_RS MAC CE contains information that cause A-SCell to transition to D2-SCell, UE performs beam_failure_operation:

UE may, for the SCell:
set BFI COUNTER of each BFD-RS set of SCell to 0;
consider the Beam Failure Recovery procedure successfully completed and cancel all the triggered BFRs of all BFD-RS sets of the Serving Cell.

When a OD_SS RS MAC CE is received at slot n of the first cell, UE performs:
beam_failure_operation for the second cell at a first point of time;
   the first point of time is n+number of slots per subframes of a specific BWP of the second cell; the specific BWP is firstActiveUplinkBWP or initialUplinkBWP;
CSI reporting on the serving cell at a second point of time;
   the second point of time is n+3*number of slots per subframe of a specific BWP of a third cell; the third cell is the cell where CSI on PUCCH is transmitted; the specific BWP is UL BWP where CSI on PUCCH is transmitted.
The first point of time is earlier than the second point of time.

When a SCell is deactivated, UE stops actions related to CSI reporting on a serving cell (e.g. PCell or PUCCH SCell):
at n+k if SCell deactivation is caused by SCell A/D MAC CE (e.g. deactivation command in a PDSCH);
   k is m+3*number of slots per subframe of a specific BWP of a third cell;
   the third cell is the cell where CSI on PUCCH is transmitted;
   the specific BWP is UL BWP where CSI on PUCCH is transmitted;
   n is a slot where UE receives a deactivation command for the SCell in PDSCH;
   n+m is a slot indicated for PUCCH transmission with HARQ-ACK information for the PDSCH reception (e.g. slot where HARQ ACK for SCell A/D MAC CE is transmitted)
at n+h if SCell deactivation is caused by OD_SS_RS MAC CE (e.g. deactivation command in PDCCH);
   h is 3*number of slots per subframe of a specific BWP of a third cell;
   the third cell is the cell where CSI on PUCCH is transmitted;
   the specific BWP is UL BWP where CSI on PUCCH is transmitted;
   n is a slot where UE receives a deactivation command for the SCell in PDCCH;
at the first slot after slot n+j;
   j is 3*number of slots per subframe of a specific BWP of the SCell;
   the specific BWP is the active DL BWP of the SCell;
   n is a slot when sCellDeactivation Timer associated with the secondary cell expires

### <SCell_Status_Change_Determination>

A OD_SS_RS MAC CE is received at slot n of a first cell (one of one or more specific serving cells) and the OD_SS_RS MAC CE contains information related to a second cell:
if [SSB indication in a block number M that corresponds to the second sell is set to 0] and [the second cell is activated when OD_SS_RS MAC CE is received (e.g. the second cell is A-SCell];
   UE determines that SSB transmission of the second cell will stop at specific time point of the second cell (or UE determines that SSB of the second cell will be unavailable after specific time point of the second cell);
   UE determines that SCell changes from A-SCell to D2-SCell (e.g. state transition from D1-SCell to D2-SCell occurs).
if [SSB indication in a block number M that corresponds to the second sell is set to 0] and [the second cell is not activated when OD_SS_RS MAC CE is received] and [the SSB has been transmitted in the second cell before the reception of OD_SS_RS MAC CE (e.g. the second cell is D1-SCell)];
   UE determines that SSB transmission of the second cell will stop at specific time point of the second cell (or UE determines that SSB of the second cell will be unavilable after specific time point of the second cell);
   UE determines that SCell changes from D1-SCell to D2-SCell (e.g. state transition from D1-SCell to D2-SCell occurs).
if [a block number M that corresponds to the second cell is set to 1] and [the second cell is not activated when OD_SS_RS MAC CE is received] and [the SSB was not transmitted in the second cell before the reception of OD_SS_RS MAC CE (e.g. the SCell is D2-SCell)];
   UE determines that SSB transmission of the second cell will start at specific time point of the second cell (or UE determines that SSB of the second cell will be available after specific time point of the second cell);
   UE determines that the SCell changes from D2-SCell to D1-SCell (e.g. state transition from D2-SCell to D1-SCell occurs).
if [a block number M that corresponds to a second cell is set to 1] and [the second cell is not activated when OD_SS_RS MAC CE is received] and [the SSB has been transmitted in the second cell before the reception of OD_SS_RS MAC CE (e.g. the second cell is D1-SCell)];
   UE determines that SSB transmission of the second cell does not change (e.g. continue before and after reception of the OD_SS_RS MAC CE);
   UE determines that second cell stay as D1-SCell (e.g. state transition does not occurs).
if [a block number M that corresponds to a second cell is set to 0] and [the second cell is not activated when OD_SS_RS MAC CE is received] and [the SSB has been transmitted before the reception of OD_SS_RS MAC CE (e.g. the second cell is D2-SCell)];
   UE determines that SSB transmission of the second cell does not change (e.g. no SSB transmission before and after reception of the OD_SS_RS MAC CE);
   UE determines that second cell stay as D2-SCell (e.g. state transition does not occurs).
   The specific time point is either slot n+h or determined from SSB time offset.

A SCell A/D MAC CE is received at slot n of a third cell (a serving cell among currently active serving cells) and the SCell A/D MAC CE contains information related to the second cell:
if [Ci bit that corresponds to the second cell is set to 1] and [the second cell is not activated when the SCell A/D MACE is received] and [the SSB has been transmitted before the reception of SCell A/D MAC CE (e.g. the second cell is D2-SCell)]
   UE determines that SSB transmission of the second cell will start at slot n+k*x+1 of the second cell (or UE determines that SSB of the second cell will be available after slot n+k*x+1 of the second cell);
   UE determines that the SCell changes from D2-SCell to D1-SCell (e.g. state transition from D2-SCell to D1-SCell occurs).

At 1195, UE performs, considering the changed status, measurement related operations. UE may perform serving_cell_measurement_operation_adjusted for each SCell.

### <Serving_Cell_Measurement_Operation_Adjusted>

for each SCell for which servingCellMO is configured, UE performs followings:
   if the SCell was A-SCell or D1-SCell before reception of DCI 2-10; and
   if the SCell becomes D2-SCell due to reception of DCI 2-10 at slot n of a serving cell;
      UE performs followings at slot n+1 of the serving cell:
         stop measuring SS/PBCH blocks of the SCell;
         stop deriving layer 3 filtered RSRP and RSRQ per beam for the SCell (e.g. initialize Mn, Fn and Fn−1 to zero);
         remove the SCell in relevant cellsTriggeredList (to prevent D2-SCell fulfilling leaving condition and triggering measurement report procedure) where the SCell was included.
if the SCell was D2-SCell; and
   if the SCell becomes D1-SCell due to reception of DCI 2-10 at slot n of a serving cell;
      UE performs followings at slot n+c+y of the SCell:
         start measuring SS/PBCH block of the SCell based on SSB-ToMeasure in the ServingCellConfigCommon of the SCell;
         start deriving filtered RSRP and RSRQ per beam for the SCell (e.g. start updating Fn based on Mn and Fn−1)
   if the SCell becomes A-SCell due to reception of SCell A/D MAC CE at slot n of a serving cell;
      UE performs followings at slot n+m of a serving cell where HARQ ACK is transmitted;
         start measuring SS/PBCH block of the SCell based on SSB-ToMeasure in the ServingCellConfigCommon of the SCell;
         start deriving filtered RSRP and RSRQ per beam for the SCell (e.g. start updating Fn based on Mn and Fn−1)

UE performs evaluation on measurement report triggering. UE performs applicable_cell_determination_after_SCell_status_change to determine applicable cells and neighbouring cells. UE performs determining_whether_to_perform_measurement_reporting_triggering_evaluation_after_SCell_status_change for measId configured with the first type event. UE performs measurement_report_triggering_evaluation. UE performs measurement_report_triggering_evaluation. UE may perform measurement_report_initiating_on_entering or measurement_report_initiating_on_leaving or both. UE may perform cellTriggeredList_upadte.

### <Applicable_Cell_Determination_after_SCell_Status_Change>

For first type event: (same as applicable_cell_determination)
For a measId that is configured with a first type event (alternatively, for each measId, for which the first type event is configured in the corresponding reportConfig):
   UE considers only the serving cell to be applicable for the first event (alternatively, UE consider a specific SCell to be applicable for the event; the specific SCell is the SCell that is associated with a specific measObject; the specific measObject is associated with a specific reportConfig; the reportConfig configures the first type event).

For second type event:
For a measId that is configured with a second type event (alternatively, for each measId, for which the second type event is configured in the corresponding reportConfig):
   if the concerned measObjectNR (the measObjectNR associated with the measId) is associated with a SCell,
      if the SCell associated with the measObjectNR was A-SCell or D1-SCell before reception of OD_SS_RS MAC CE and becomes D2-SCell due to reception of OD_SS_RS MAC CE; or
      if the SCell associated with the measObjectNR was D2-SCell before reception of OD SS RS MAC CE and continues to be D2-SCell due to reception of OD_SS_RS MAC CE,
         UE considers the SCell neither neighbouring cell nor to be applicable.
      if the SCell associated with the measObjectNR was D2-SCell before reception of OD SS RS MAC CE and becomes D2-SCell due to reception of OD_SS_RS MAC CE; or
      if the SCell associated with the measObjectNR was A-SCell or D1-SCell before reception of OD_SS_RS MAC CE and continues to be A-SCell or D1-SCell due to reception of OD SS RS MAC CE,
         UE considers the SCell to be a neighbouring cell as well;
         if useAllowedCellList is set to true and if the SCell is included in the allowedCellsToAddModList,
         UE considers the SCell to be applicable.
         if useAllowedCellList is set to true and if the SCell is not included in the allowedCellsToAddModList,
         UE considers the SCell to be not applicable.
         if useAllowedCellList is set to false and if the SCell is not included in the excludedCellsToAddModList,
         UE considers the SCell to be applicable.
         if useAllowedCellList is set to false and if the SCell is included in the excludedCellsToAddModList,
         UE considers the SCell to be not applicable.
      if the SCell associated with the measObjectNR is D2-SCell,
      UE considers the SCell neither neighbouring cell nor to be applicable.

For third type event (same as applicable_cell_determination)
For a measId that is configured with a third type event (alternatively, for each measId, for which the third type event is configured in the corresponding reportConfig):
   if the concerned measObjectNR (the measObjectNR associated with the measId) is associated with a SCell,
      UE considers the SCell neither neighbouring cell nor to be applicable.

### <Determining_Whether_to_Perform_Measurement_Report_Triggering_Evaluation_after_SCell_Status Change>

For first type event:
For a measId that is configured with a first type event (alternatively, for each measId, for which the first type event is configured in the corresponding reportConfig):
   if the applicable cell for the first type event becomes A-SCell or D1-SCell due to reception of OD_SS_RS MAC CE or SCell A/D MAC CE; and
   if the applicable cell was D2-SCell before the reception of DCI2_10 or SCell A/D MAC CE;
      UE determines to start measurement_reporting_triggering_evaluation for the measId;
if the applicable cell for the first type event becomes D2-SCell due to reception of OD SS RS MAC CE; and
   if the applicable cell was D1-SCell or A-SCell before the reception of DCI2_10;
      UE determines to stop measurement_reporting_triggering_evaluation for the measId;
         <cellsTriggeredList_Update_after_SCell_Status_Chagne>

For cells TriggeredList_update_after_SCell_status_change for a measId, UE may:
if a one or more cells included in the cellsTriggeredList becomes D2-SCell due to reception of OD_SS_RS MAC CE;
   remove the one or more cells in the cellsTriggeredList for the MeasId; and
   not initiate the measurement reporting procedure.
if the entry condition applicable for the event associated with the measId is fulfilled for one or more cells for all measurements after layer3 filtering taken during time ToTriggered; and
if the one or more cells are not included in cellTriggeredList:
   include the one or more cells in the cellsTriggeredList for the MeasId; and initiate the measurement reporting procedure;
if the leaving condition applicable for the event associated with the measId is fulfilled for one or more of the cells for all measurements after layer3 filtering taken during time ToTriggered; and
if the one or more cells are included in cellTriggeredList:
   remove the one or more cells in the cellsTriggeredList for the MeasId; and
   initiate the measurement reporting procedure.

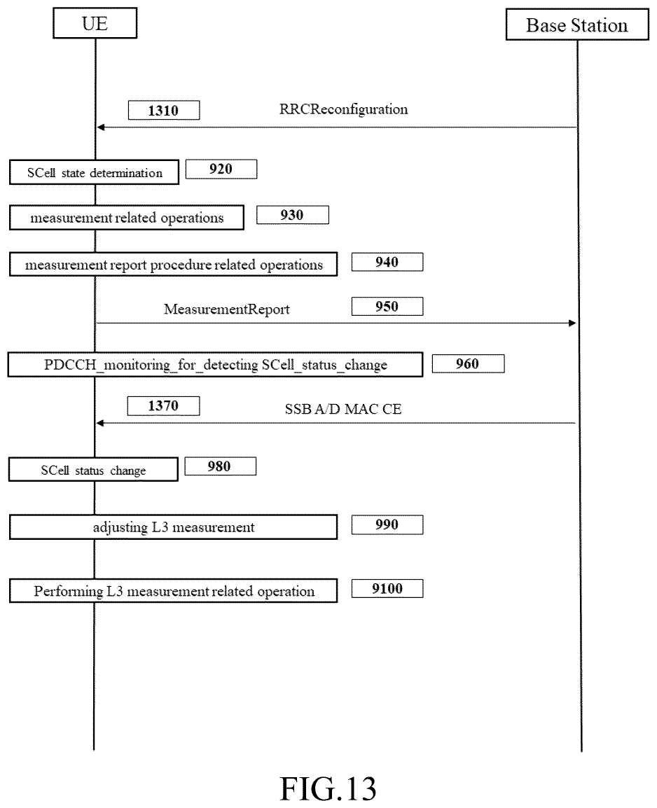

FIG. 13 illustrates operations of UE and base station for another embodiment.

At 1310 UE receives from the GNB a RRCReconfiguration message. The RRCRecofniguration message includes following fields/IEs in addiction to what are disclosed in 910.

RRCReconfiguration message includes a CellGroupConfig IE. The CellGroupConfig IE includes one or more SCellConfig IEs A100.

SCellConfig IE (A100) includes following fields/IEs.

sCellState indicates whether the SCell shall be considered to be in activated state upon SCell configuration.

secondaryDRX-GroupConfig is used to indicate whether the SCell belongs to the secondary DRX group. All serving cells in the secondary DRX group shall belong to one Frequency Range and all serving cells in the default DRX group shall belong to another Frequency Range.

smtc indicates the SSB periodicity/offset/duration configuration of target cell for NR SCell addition. The network sets the periodicityAndOffset to indicate the same periodicity as ssb-periodicityServingCell in sCellConfigCommon. The smtc is based on the timing of the SpCell of associated cell group. If the field is absent and absoluteFrequencySSB is included, the UE uses the SMTC in the measurement object configuration (measObjectNR) having the same SSB frequency and subcarrier spacing, as configured before the reception of the RRC message. If the SCell is a first type SSB-less SCell (i.e., the IE absoluteFrequencySSB in ServingCellConfigCommon is absent), this field is absent. If the SCell is a second type SSB-less SCell (i.e., the IE absolute FrequencySSB in ServingCellConfigCommon is present; the SCell is configured with on demand SSB), this field is present.

SCellConfig IE may include smtc_od_ssb field. This field includes SSB-MTC IE. This field indicates SSB periodicity/offset/duration configuration of OD-CD-SSB of target cell for NR SCell addition. The network sets the periodicityAndOffset to indicate the same periodicity as ssb-Periodicity (A250) in sCellConfigCommon. The smtc_od_ssb is based on the timing of the SpCell of associated cell group.

ServingCellConfigCommon (A110) includes cell specific configuration parameters for the SCell.

downlinkConfigCommon indicates the common downlink configuration of the serving cell, including the frequency information configuration and the initial downlink BWP common configuration.

LongBitmap is bitmap when maximum number of SS/PBCH blocks per half frame equals to 64 n-TimingAdvanceOffset indicates the N_TA-Offset to be applied for all uplink

transmissions on this serving cell if n-TimingAdvanceOffset2 is not configured. If tag2 is configured for this serving cell, this field is to be applied to all uplink transmissions associated to tag-id configured for this serving cell. If the field is absent, the UE applies the value defined for the duplex mode and frequency range of this serving cell.

shortBitmap is bitmap when maximum number of SS/PBCH blocks per half frame equals to 4.

ss-PBCH-BlockPower indicates average EPRE of the resources elements that carry secondary synchronization signals in dBm that the NW used for SSB transmission.

ssb-periodicityServingCell indicates the SSB periodicity of AO-CD-SSB in ms for the rate matching purpose. If the field is absent, the UE applies the value ms5.

ssb-PositionsInBurst indicates the time domain positions of the transmitted SS-blocks in a

half frame with SS/PBCH blocks as defined in TS 38.213 [13], clause 4.1. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted. The network configures the same pattern in this field as in the corresponding field in ServingCellConfigCommonSIB.

ssbSubcarrierSpacing indicates Subcarrier spacing of SSB.

onDemandSsbConfig includes OnDemandSsbConfig.

Conditional Presence is defined as below.

AbsFreqSSB means that the field is absent when absoluteFrequencySSB in frequencyInfoDL is absent, otherwise the field is mandatory present.

HOAndServCellAdd means that this field is mandatory present upon SpCell change (including path switch between a serving cell and a L2 U2N Relay UE) and upon serving cell (PSCell/SCell) addition. Otherwise, the field is absent.

HOAndServCellWithSSB means that this field is mandatory present upon SpCell change andupon serving cell (SCell with SSB or PSCell) addition. Otherwise, the field is absent.

Cond OD-SSB-lessSCell means that this field is mandatory present when SSB is semi-persistently or aperiodically transmitted in the serving cell. Otherwise, the field is absent. OnDemandSsbConfig IE indicates cofiguration of OD-CD-SSB. It includes following fields/IEs.
oDssb-timeOffset:
   This field indicates the time offset between:
      when activation command is received and when transmission of OD-CD-SSB starts; or
      a slot n where HARQ ACK for activation command is transmitted and a slot n+m+x, where m is determined by oDssb-timeOffset and x is the slot of the corresponding SCell where earliest SMTC for OD-CD-SSB occurs after slot n+m;
ssb-Periodicity (A250);
absoluteFrequencySSB (A260);
either OD-SSB-SP-Config IE or OD-SSB-AP-Config IE.

OD-SSB-SP-Config IE provides configuration parameters for semi-persistent OD-SSB. If this IE is present, UE considers SP OD-CD-SSB is configured for the initial BWP of the SCell. This IE includes following fields/IEs.
initial_state_field indicates initial state of SP OD-CE-SSB. If it is set to ‘enabled’, UE considers SP OD-CD-SSB being transmitted in the initial downlink BWP of the SCell. If it is set to ‘disabled’, SP OD-CD-SSB is not transmitted in the initial downlink BWP of the SCell.

OD-SSB-AP Config IE provides configuration parameters for aperiodically transmitted OD-SSB (AP OD-SSB). If this IE is present, UE considers that OD-CD-SSB-AP is configured for the initial BWP of the SCell. This IE includes following fields/IEs.
nrOfoDssbBurst;
   This field indicates number of AP-OD-SSB bursts to be transmitted upon activation command reception.

OnDemandNonCellDefiningSSB IE indicates configuration of OD-NCD-SSB. It includes following fields/IEs.
oDssb-timeOffset:
   This field indicates the time offset between:
      when activation command is received and when transmission of OD-NCD-SSB starts in the concerned dedicate BWP; or
      a slot n where HARQ ACK for activation command is transmitted and a slot n+m+x, where m is determined by oDssb-timeOffset and x is the slot of the corresponding SCell where the earliest SMTC for OD-NCD-SSB occurs after slot n+m;
ssb-Periodicity (A300);
   if this field is absent, UE determines that periodicity of SP OD-NCD-SSB is same as periodicity of AO-NCD-SSB (ssb-Periodicity (A280) in the BWP-Downlink of the same BWP);
absolute FrequencySSB (A290);
if this field is absent, UE determines that frequency of SP OD-NCD-SSB is same as frequency of AO-NCD-SSB (absoluteFrequencySSB (A270) in the BWP-Downlink of the same BWP);
either OD-SSB-SP-Config IE or OD-SSB-SP-Config IE.

OD-SSB-SP-Config IE in BWP-DownlinkDedicated provides configuration parameters for semi-persistent OD-NCD-SSB. If this IE is present, UE considers SP OD-NCD-SSB is configured for the dedicated BWP of the SCell. This IE includes following fields/IEs.
initial_state_field indicates initial state of SP OD-NCD-SSB. If it is set to ‘enabled’, UE considers SP OD-NCD-SSB being transmitted in the concerned downlink BWP of the SCell. If it is set to ‘disabled’, SP OD-NCD-SSB is not transmitted in the initial downlink BWP of the SCell.

OD-SSB-AP Config IE in BWP-DownlinkDedicated provides configuration parameters for aperiodically transmitted OD-NCD-SSB (AP OD-NCD-SSB). If this IE is present, UE considers AP OD-NCD-SSB is configured for the concerned dedicated BWP of the SCell. This IE includes following fields/IEs.
nrOfoDssbBurst;
   This field indicates number of AP-OD-NCD-SSB bursts to be transmitted upon activation command reception.

ServingCellConfig A120 includes UE specific configuration parameters for the SCell.

bwp-InactivityTimer indicates the duration in ms after which the UE falls back to the default Bandwidth Part (see TS 38.321 [3], clause 5.15). When the network releases the timer configuration, the UE stops the timer without switching to the default BWP.

ca-SlotOffset indicates slot offset between the primary cell (PCell/PSCell) and the SCell in unaligned frame boundary with slot alignment and partial SFN alignment inter-band CA. Based on this field, the UE determines the time offset of the SCell as specified in clause 4.5 of TS 38.211 [16]. The granularity of this field is determined by the reference SCS for the slot offset (i.e. the maximum of PCell/PSCell lowest SCS among all the configured SCSs in DL/UL SCS-SpecificCarrierList in ServingCellConfigCommon or ServingCellConfigCommonSIB and this serving cell's lowest SCS among all the configured SCSs in DL/UL SCS-SpecificCarrierList in ServingCellConfigCommon or ServingCellConfigCommonSIB). The Network configures at most single non-zero offset duration in ms (independent on SCS) among CCs in the unaligned CA configuration. If the field is absent, the UE applies the value of 0. The slot offset value can only be changed with SCell release and add.

crossCarrierSchedulingConfig indicates whether this serving cell is cross-carrier scheduled by another serving cell or whether it cross-carrier schedules another serving cell. If the field other is configured for an SpCell (i.e., the SpCell is cross-carrier scheduled by another serving cell), the SpCell can be additionally scheduled by the PDCCH on the SpCell.

downlinkBWP-ToAddModList is list of additional downlink bandwidth parts to be added or modified. It includes one or more BWP-Downlink IEs. Each BWP-Downlink IE includes one or more BWP-DownlinkDedicated IE 2H10.

downlinkBWP-ToReleaseList is list of additional downlink bandwidth parts to be released.

firstActiveDownlinkBWP-Id, if configured for an SpCell, contains the ID of the DL BWP to be activated or to be used for RLM, BFD and measurements if included in an

RRCReconfiguration message contained in an NR or E-UTRA RRC message indicating that the SCG is deactivated, upon performing the RRC (re-)configuration. If the field is absent, the RRC (re-)configuration does not impose a BWP switch. If configured for an SCell, this field contains the ID of the downlink bandwidth part to be used upon activation of an SCell. The initial bandwidth part is referred to by BWP-Id=0.

initialDownlinkBWP is the dedicated (UE-specific) configuration for the initial downlink bandwidth-part (i.e., DL BWP #0). If any of the optional IEs are configured within this IE, the UE considers the BWP #0 to be an RRC configured BWP (from UE capability viewpoint). Otherwise, the UE does not consider the BWP #0 as an RRC configured BWP (from UE capability viewpoint). Network always configures the UE with a value for this field if no other BWPs are configured.

pathlossReference Linking indicates whether UE shall apply as pathloss reference either the downlink of SpCell (PCell for MCG or PSCell for SCG) or of SCell that corresponds with this uplink (see TS 38.213 [13], clause 7).

sCellDeactivation Timer indicates the initial value of SCell deactivation timer in TS 38.321 [3]. If the field is absent, the UE applies the value infinity. servingCellMO indicates measObjectId of the MeasObjectNR in MeasConfig which is associated to the serving cell.

BWP-DownlinkDedicated IE A130 includes following fields/IEs.

beam FailureRecoverySCellConfig includes configuration of candidate RS for beam failure recovery on SCells.

beamFailureRecoverySpCellConfig includes configuration of candidate RS for beam failure recovery on the SpCell. This field can only be configured when beamFailure-r17 is configured in RadioLinkMonitoringConfig.

nonCellDefiningSSB includes parameters for NCD-SSB. The UE operating in this BWP uses this SSB for the purposes for which it would otherwise have used the CD-SSB of the serving cell (e.g. obtaining sync, measurements, RLM, BFD, beam management). Furthermore, other parts of the BWP configuration that refer to an SSB (e.g. the “SSB” configured in the QCL-Info IE; the “ssb-Index” configured in the RadioLinkMonitoringRS; CFRA-SSB-Resource; PRACH-Resource DedicatedBFR) refer implicitly to this NCD-SSB. The NCD-SSB has the same values for the properties (e.g., ssb-PositionsInBurst, PCI, ssb-PBCH-BlockPower) of the corresponding CD-SSB apart from the values of the properties configured in the NonCellDefiningSSB-r17 IE. In the MIB associated with this NCD-SSB, the systemFrameNumber field indicates the frame boundary and frame number of the NCD-SSB. The subCarrierSpacingCommon and dmrs-TypeA-Position field in the MIBs associated with CD-SSB and NCD-SSB in the same cell are configured with the same values, respectively.

pdcch-Config indicates UE specific PDCCH configuration for one BWP.

pdsch-Config indicates UE specific PDSCH configuration for one BWP.

servingCellMO indicates measObjectId of the MeasObjectNR in MeasConfig which is associated to the serving cell.

sps-Config indicates UE specific SPS (Semi-Persistent Scheduling) configuration for one BWP.

sps-ConfigToAddModList indicates a list of one or more DL SPS configurations to be added or modified in one BWP. Except for reconfiguration with sync, the NW does not reconfigure a SPS configuration when it is active (see TS 38.321 [3]).

sps-Config ToRelease List indicates a list of one or more DL SPS configurations to be released. The NW may release a SPS configuration at any time.

radio LinkMonitoringConfig indicates UE specific configuration of radio link monitoring for detecting cell- and beam radio link failure occasions. The maximum number of failure detection resources should be limited up to 8 for both cell and beam radio link failure detection. For SCells, only periodic 1-port CSI-RS can be configured in IE RadioLinkMonitoringConfig.

Conditional Presence is defined as below.

MeasObject-NCD-SSB means that this field is optionally present, Need S, if nonCellDefiningSSB is configured in this DL BWP. It is absent otherwise.

ScellOnly means that the field is optionally present, Need M, in the BWP-DownlinkDedicated of an Scell. It is absent otherwise.

SpCellOnly means that the field is optionally present, Need M, in the BWP-DownlinkDedicated of an Spcell. It is absent otherwise.

nonCellDefiningSSB IE A140 includes following fields/IEs.

absolute FrequencySSB indicates frequency of the NCD-SSB. The network configures this field so that the SSB is within the bandwidth of the BWP configured in BWP-DownlinkCommon.

ssb-Periodicity indicates the periodicity of this NCD-SSB. the network configures only periodicities that are larger than the periodicity of serving cell's CD-SSB. If the field is absent, the UE applies the SSB periodicity of the CD-SSB (ssb-periodicityServingCell configured in ServingCellConfigCommon or ServingCellConfigCommonSIB).

ssb-TimeOffset indicates the time offset between CD-SSB of the serving cell and this NCD-SSB. Value ms5 means the first burst of NCD-SSB is transmitted 5 ms later than the first burst of CD-SSB transmitted after the first symbol of SFN=0 of the serving cell, value ms10 means the first burst of NCD-SSB is transmitted 10 ms later than the first burst of CD-SSB transmitted after the first symbol in SFN=0 of the serving cell, and so on. If the field is absent, UE considers that the time offset between the first burst of CD-SSB transmitted in the serving cell and the first burst of this NCD-SSB transmitted is zero. For UEs in TDD cells, the network configures this time offset to be an integer multiple of the periodicity of the serving cell's CD-SSB.

The IE DownlinkConfigCommon A150 provides common downlink parameters of a cell.

frequencyInfoDL includes basic parameters of a downlink carrier and transmission thereon.

initialDownlinkBWP indicates the initial downlink BWP configuration for a serving cell. The network configures the locationAndBandwidth so that the initial downlink BWP contains the entire CORESET #0 of this serving cell in the frequency domain.

The IE FrequencyInfoDL includes following IEs/fields.

absoluteFrequencyPointA indicates Absolute frequency position of the reference resource block (Common RB 0). Its lowest subcarrier is also known as Point A (see TS 38.211 [16], clause 4.4.4.2). Note that the lower edge of the actual carrier is not defined by this field but rather in the scs-SpecificCarrierList.

absolute FrequencySSB indicates frequency of the SSB to be used for this serving cell. SSB related parameters (e.g. SSB index) provided for a serving cell refer to this SSB frequency unless mentioned otherwise. The CD-SSB of the PCell is always on the sync raster. Frequencies are considered to be on the sync raster if they are also identifiable with a GSCN value (see TS 38.101-1 [15] or TS 38.101-5 [75]). If the field is absent, the SSB related parameters should be absent, e.g. ssb-PositionsInBurst, ssb-periodicityServingCell and subcarrierSpacing in ServingCellConfigCommon IE. If the field is absent, the UE obtains timing reference from the intra-band SpCell or intra-band SCell if applicable as described in TS 38.213 [13], clause 4.1, or from the SpCell or an SCell indicated by referenceCell, or from the reference serving cell defined in TS 38.133 [14]. This is supported in case the SCell for which the UE obtains the timing reference is in the same or different frequency band as the cell (i.e. the SpCell or the SCell, respectively) from which the UE obtains the timing reference.

For PCell, this field corresponds to the AO-CD-SSB.

frequencyBandList includes list containing only one frequency band to which this carrier(s) belongs. Multiple values are not supported.

referenceCell indicates the reference cell, i.e. the cell which provides the timing reference and AGC source for the inter-band SSB-less SCell. If the reference cell is an SCell or PSCell, it should be an activated SCell or activated PSCell.

scs-SpecificCarrierList indicates a set of carriers for different subcarrier spacings (numerologies). Defined in relation to Point A. The network configures a scs-SpecificCarrier at least for each numerology (SCS) that is used e.g. in a BWP (see TS 38.211 [16], clause 5.3).

The IE MeasObjectNR A160 specifies information applicable for SS/PBCH block(s) intra/inter-frequency measurements and/or CSI-RS intra/inter-frequency measurements

smtc1 indicates primary measurement timing configuration. (see clause 5.5.2.10).

smtc2 indicates secondary measurement timing configuration for SS corresponding to this MeasObjectNR with PCI listed in pci-List. For these SS, the periodicity is indicated by periodicity in smtc2 and the timing offset is equal to the offset indicated in periodicity AndOffset modulo periodicity.

ssbFrequency indicates the frequency of the SS associated to this MeasObjectNR. Frequencies are considered to be on the sync raster if they are also identifiable with a GSCN value (see TS 38.101-1 [15], or TS 38.101-5 [75]).

ssbSubcarrierSpacing indicates subcarrier spacing of SSB.

The IE SSB-MTC A22 is used to configure measurement timing configurations, i.e., timing occasions at which the UE measures SSBs.

duration indicates duration of the measurement window in which to receive SS/PBCH blocks. It is given in number of subframes (see TS 38.213 [13], clause 4.1).

periodicityAndOffset indicates periodicity and offset of the measurement window in which to receive SS/PBCH blocks, see 5.5.2.10. Periodicity and offset are given in number of subframes.

At 1370 UE receives from the GNB a SSB Activation/Deactivation MAC CE (SSB A/D MAC CE). The SSB A/D MAC CE M100 is identified by a MAC subheader with a LCID and an eLCID. It has a fixed size and consists of a single octet containing seven S-fields.
S_i: This field indicates the activation/deactivation status of OD-SSB transmission in SCell i where i is the ascending order of the SCellIndex among the SCells configured with OD-SSB. The S_i field is set to 1 to indicate that SSB transmission of SCell i (SCell with i-th lowest SCellIndex) shall be activated. The S_i field is set to 0 to indicate that the OD-SSB transmission in SCell i shall be deactivated.
R: Reserved bit, set to 0.

Upon receiving SSB A/D MAC CE, UE performs followings. The reason to perform followings is to activate/deactivate OD-SSB in proper BWP at proper time point.

If SSB A/D/MAC CE activates OD SSB of a SCell that is deactivated,
UE activates OD-SSB in the initial BWP;
UE activates OD-SMTC.

If SSB A/D/MAC CE activates OD SSB of a SCell that is activated,
UE activates OD-SSB in the currently activated BWP;
UE activates OD-SMTC.

If SSB A/D/MAC CE deactivates OD SSB of a SCell that is deactivated,
UE deactivates OD-SSB in the initial BWP;
   UE deactivates OD-SMTC.

If SSB A/D/MAC CE deactivates OD SSB of a SCell that is activated,
UE deactivates OD-SSB in the currently activated BWP;
UE deactivates OD-SMTC.

### <UE Operations Upon Reception of SSB Activation/Deactivation MAC CE>

Operations for Deactivated SCell with OD-CD-SSB in Initial BWP

Upon receiving the SSB Activation/Deactivation MAC CE for a deactivated SCell, the UE performs the following operations based on the state of the corresponding S_i bit and the current state of OD-SSB transmission:

When the S_i bit is set to 1 and OD-SSB is in a deactivated state: The UE activates the OD-CD-SSB in the initial BWP at slot n+m+x. The UE considers that OD-CD-SSB transmission will start at slot n+m+x and will be ongoing until deactivated. Correspondingly, the OD-SMTC is activated at slot n+m+x. The UE performs measurement on the CD-SSB based on the AO-SMTC until or before slot n+m+x, and based on both the AO-SMTC and the OD-SMTC after slot n+m+x.

When the S_i bit is set to 1 and OD-SSB is in an activated state: The UE determines that the OD-CD-SSB in the initial BWP is ongoing and ignores the bit. The OD-SMTC continues to be activated. The UE performs measurement on the CD-SSB based on both the AO-SMTC and the OD-SMTC before and after slot n+m+x.

When the S_i bit is set to 0 and OD-SSB is in a deactivated state: The UE determines that the OD-CD-SSB in the initial BWP continues to be deactivated and ignores the bit. The OD-SMTC continues to be deactivated. The UE performs measurement on the CD-SSB based on the SMTC before and after slot n+1.

When the S_i bit is set to 0 and OD-SSB is in an activated state: The UE deactivates the OD-CD-SSB in the initial BWP at slot n+1. The UE considers that OD-CD-SSB transmission will stop at slot n+1 and will be deactivated until activated again. The OD-SMTC is deactivated at slot n+1. The UE performs measurement on the CD-SSB based on both the AO-SMTC and the OD-AO-SMTC until or before slot n+1, and based on the SMTC after slot n+1.

Operations for Activated SCell with OD-NCD-SSB in Currently Active BWP

Upon receiving the SSB Activation/Deactivation MAC CE for an activated SCell, the UE performs the following operations based on the state of the corresponding S_i bit and the current state of OD-SSB transmission:

When the S_i bit is set to 1 and OD-SSB is in a deactivated state: The UE activates the OD-NCD-SSB at slot n+m+x. The UE considers that OD-NCD-SSB transmission will start at slot n+m+x and will be ongoing until deactivated. The OD-SMTC is activated at slot n+m+x. The UE performs measurement on the NCD-SSB based on the AO-SMTC until or before slot n+m_1+x_1, and based on both the AO-SMTC and the OD-SMTC after slot n+m+x.

When the S_i bit is set to 1 and OD-SSB is in an activated state: The UE determines that the OD-CD-SSB in the initial BWP is ongoing. The OD-SMTC continues to be activated. The UE performs measurement on the NCD-SSB based on both the AO-SMTC and the OD-SMTC before and after slot n+m_1+x_1.

When the S_i bit is set to 0 and OD-SSB is in a deactivated state: The UE determines that the OD-CD-SSB in the initial BWP continues to be deactivated. The OD-SMTC continues to be deactivated. The UE performs measurement on the NCD-SSB based on the SMTC before and after slot n+1_1.

When the S_i bit is set to 0 and OD-SSB is in an activated state: The UE deactivates the OD-CD-SSB in the initial BWP at slot n+1. The UE considers that OD-CD-SSB transmission will stop at slot n+1 and will be deactivated until activated again. The OD-SMTC is deactivated at slot n+1. The UE performs measurement on the NCD-SSB based on both the AO-SMTC and the OD-SMTC until or before slot n+1_1, and based on the AO-SMTC after slot n+1_1.

OD-CD-SSB being activated at a specific time point means that transmission of the OD-CD-SSB starts in the initial BWP at the specific time point.

OD-NCD-SSB being activated at a specific time point means that transmission of the OD-NCD-SSB starts in the currently active BWP at the specific time point.

OD-SMTC being activated at a specific time point means that UE starts performing measurement on the corresponding OD-SSB of a specific BWP using the OD-SMTC from the specific time point.

slot n is the slot of currently active BWP of the SpCell when:
the MAC CE is received; or
HARQ ACK for the MAC CE is transmitted.

Alternatively, slot n is the slot of a specific BWP of a specific serving cell corresponding to the slot of currently active BWP of the SpCell when:
the MAC CE is received; or
HARQ ACK for the MAC CE is transmitted.

slot m is the slot of the initial BWP of the SCell which is:
determined based on oDssb-timeOffset and the slot length of the initial BWP of the SCell; and
equal to floor (oDssb-timeOffset, slot length of the initial BWP of the SCell).

slot m_1 is the slot of the currently active BWP of the SCell which is:
determined based on oDssb-timeOffset and the slot length of the currently active BWP of the SCell; and
equal to floor (oDssb-timeOffset, slot length of the currently active BWP of the SCell).

slot x is the slot of the initial BWP of the SCell which, according to OD-SMTC, occurs first since slot n+x

slot x_1 is the slot of the currently active BWP of the SCell which, according to OD-SMTC, occurs first since slot n+x

Upon receiving SCell A/D MAC CE, UE performs followings. The reason to perform followings is to activate/deactivate OD-SSB in proper BWP at proper time point.

If SCell is deactivated while OD-SSB is enabled, UE deactivates OD-SSB in the currently active BWP and activates OD-SSB in the initial BWP.

If SCell is deactivated while OD-SSB is disabled, UE does not perform activation/deactivation of OD-SSB in any BWP.

If SCell is activated while OD-SSB is enabled, UE deactivates OD-SSB in the initial BWP and activates OD-SSB in the first active BWP.

If SCell is activated while OD-SSB is disabled, UE does not perform activation/deactivation of OD-SSB in any BWP.

Alternatively, UE activates OD-SSB in the deactivates OD-SSB in the initial BWP and activates OD-SSB in the first active BWP.

### <UE Operations Upon Reception of SCell Activation/Deactivation MAC CE>

Upon receiving the SCell Activation/Deactivation MAC CE, the UE performs the following operations to activate or deactivate OD-SSB in the proper BWP at the proper time point.

Case 1: SCell State Transition from Deactivated to Activated with Enabled OD-SSB

When the SCell MAC CE causes an SCell state change from deactivated state to activated state, and OD-SSB transmission is activated or enabled when the SCell MAC CE is received, the UE performs autonomous switching operations. The OD-CD-SSB in the initial BWP is deactivated, and the OD-NCD-SSB in the first active BWP is activated. Both the SMTC and the OD-SMTC continue to be activated. The UE stops measurement on the OD-CD-SSB and starts measurement on the OD-NCD-SSB. Measurement on the CD-SSB is performed based on both the

AO-SMTC and the OD-SMTC. Measurement on the NCD-SSB is performed based on both the AO-SMTC and the OD-SMTC.

Case 2: SCell State Transition from Deactivated to Activated with Disabled OD-SSB

When the SCell MAC CE causes an SCell state change from deactivated state to activated state, and OD-SSB transmission is deactivated or disabled when the SCell MAC CE is received, the UE performs autonomous activation operations. The OD-CD-SSB in the initial BWP continues to be deactivated, and the OD-NCD-SSB in the first active BWP is activated. Alternatively, no autonomous activation occurs. The SMTC continues to be activated, and the OD-SMTC is activated. The UE stops measurement on the OD-CD-SSB and starts measurement on the OD-NCD-SSB. Measurement on the CD-SSB is performed based on the SMTC. Measurement on the NCD-SSB is performed based on both the AO-SMTC and the OD-SMTC.

Case 3: No SCell State Change in Deactivated State with Enabled OD-SSB

When the SCell MAC CE does not cause an SCell state change, the SCell state remains in the deactivated state, and OD-SSB transmission is activated or enabled when the SCell MAC CE is received, the UE performs no autonomous actions. The OD-CD-SSB in the initial BWP continues to be activated. Both the SMTC and the OD-SMTC continue to be activated. The UE continues measurement on the OD-CD-SSB. Measurement on the CD-SSB is performed based on both the SMTC and the SMTC_DD_SSB.

Case 4: No SCell State Change in Deactivated State with Disabled OD-SSB

When the SCell MAC CE does not cause an SCell state change, the SCell state remains in the deactivated state, and OD-SSB transmission is deactivated or disabled when the SCell MAC CE is received, the UE performs no autonomous actions. The OD-CD-SSB in the initial BWP continues to be deactivated. The SMTC continues to be activated, and the OD-SMTC continues to be deactivated. The UE does not perform measurement on the OD-CD-SSB.

Case 5: SCell State Transition from Activated to Deactivated with Enabled OD-SSB

When the SCell MAC CE causes an SCell state change from activated state to deactivated state, and OD-SSB transmission is activated or enabled when the SCell MAC CE is received, the UE performs autonomous switching operations. The OD-CD-SSB in the initial BWP is activated, and the OD-NCD-SSB in the first active BWP or currently active BWP is deactivated. Both the SMTC and the OD-SMTC continue to be activated. The UE stops measurement on the OD-NCD-SSB and starts measurement on the OD-CD-SSB. Measurement on the CD-SSB is performed based on both the AO-SMTC and the OD-SMTC. Measurement on the NCD-SSB is performed based on both the AO-SMTC and the OD-SMTC.

Case 6: SCell State Transition from Activated to Deactivated with Disabled OD-SSB

When the SCell MAC CE causes an SCell state change from activated state to deactivated state, and OD-SSB transmission is deactivated or disabled when the SCell MAC CE is received, no autonomous activation occurs. The OD-SSB continues to be deactivated. The SMTC continues to be activated, and the OD-SMTC is activated. The UE stops measurement on the OD-CD-SSB and starts measurement on the OD-NCD-SSB. Measurement on the CD-SSB is performed based on the SMTC. Measurement on the NCD-SSB is performed based on both the AO-SMTC and the OD-SMTC.

Case 7: No SCell State Change in Activated State with Enabled OD-SSB

When the SCell MAC CE does not cause an SCell state change, the SCell state remains in the activated state, and OD-SSB transmission is activated or enabled when the SCell MAC CE is received, the UE performs no autonomous actions. The OD-CD-SSB in the initial BWP continues to be activated. Both the SMTC and the OD-SMTC continue to be activated. The UE continues measurement on the OD-NCD-SSB. Measurement on the NCD-SSB is performed based on both the AO-SMTC and the OD-SMTC.

Case 8: No SCell State Change in Activated State with Disabled OD-SSB

When the SCell MAC CE does not cause an SCell state change, the SCell state remains in the activated state, and OD-SSB transmission is deactivated or disabled when the SCell MAC CE is received, the UE performs no autonomous actions. The OD-CD-SSB in the initial BWP continues to be deactivated. The SMTC continues to be activated, and the OD-SMTC continues to be deactivated. The UE does not perform measurement on the OD-NCD-SSB.

Activation at a specific time point: OD-CD-SSB being activated at a specific time point means that transmission of the OD-CD-SSB starts in the initial BWP at the specific time point. OD-NCD-SSB being activated at a specific time point means that transmission of the OD-NCD-SSB starts in the currently active BWP at the specific time point. OD-SMTC being activated at a specific time point means that the UE starts performing measurement on the corresponding OD-SSB of a specific BWP using the OD-SMTC from the specific time point.

Slot n: Slot n is the slot of the currently active BWP of the SpCell when the MAC CE is received or when HARQ ACK for the MAC CE is transmitted. Alternatively, slot n is the slot of a specific BWP of a specific serving cell corresponding to the slot of the currently active BWP of the SpCell when the MAC CE is received or when HARQ ACK for the MAC CE is transmitted.

Slot m: Slot m is the slot of the initial BWP of the SCell which is determined based on oDssb-timeOffset and the slot length of the initial BWP of the SCell, and is equal to floor (oDssb-timeOffset/slot length of the initial BWP of the SCell).

Slot m_1: Slot m_1 is the slot of the currently active BWP of the SCell which is determined based on oDssb-timeOffset and the slot length of the currently active BWP of the SCell, and is equal to floor (oDssb-timeOffset/slot length of the currently active BWP of the SCell).

Slot x: Slot x is the slot of the initial BWP of the SCell which, according to OD-SMTC, occurs first since slot n+m.

Slot x_1: Slot x_1 is the slot of the currently active BWP of the SCell which, according to OD-SMTC, occurs first since slot n+m_1.

If BWP switching occurs when OD-SSB is enabled in the concerned BWP:
UE deactivate the OD-SSB of the switched/source BWP and activate the OD-SSB of the switching/target BWP; and
UE stop measuring OD-SSB of the switched/source BWP and start measuring OD-SSB of the switching/target BWP.

If BWP switching occurs when OD-SSB is disabled in the concerned BWP, UE does not perform activation/deactivation of OD-SSB.

When SSB A/D MAC CE activating OD-SSBG of a SCell is received:
UE activates all OD SSBGs (OD-CD-SSBG, one or more OD-NCD-SSBGs etc) configured in all BWPs of the SCell; and
UE activates the OD-SMTC of the SCell.

When SSB A/D MAC CE deactivating OD-SSBG of a SCell is received:
UE deactivates all OD SSBGs (OD-CD-SSBG, one or more OD-NCD-SSBGs etc) configured in all BWPs of the SCell; and
UE deactivates the OD-SMTC of the SCell.

When SCell A/D MAC CE activating a SCell is received, while OD-SSBGs of the SCell is not activated:
UE activates OD-NCD-SSBG configured in the currently active downlink BWP (or first active BWP) of the SCell; and
UE activates the OD-SMTC of the SCell.

When a SCell is deactivated, while OD-SSBGs of the SCell is activated:
UE deactivates OD-NCD-SSBG in the first active BWP; and
UE activates OD-CD-SSBG in the initial BWP.

When SSB A/D MAC CE deactivating SSBG of a SCell is received:
UE deactivates all OD SSBGs (OD-CD-SSBG, one or more OD-NCD-SSBGs etc) configured in all BWPs of the SCell; and
UE deactivates the OD-SMTC of the SCell.

Followings are equivalent to each other:
dedicated BWP and RRC-configured BWP;
OD-SSB in the initial BWP and OD-CD-SSB;
OD-SSB in dedicate BWP and OD-NCD-SSB;
XX-YY-SSB and XX-YY-SSBG.

OD-SSB includes both OD-CD-SSB and OD-NCD-SSB.

That OD-SSB is enabled/activated in a BWP of a SCell means that:
OD-SSB is transmitted in the BWP of the SCell; and
UE measures OD-SSB in the BWP of the SCell according to OD-SMTC

That OD-SSB is disabled/deactivated in a BWP of a SCell means that:
OD-SSB is not transmitted in the BWP of the SCell; and
UE does not measure OD-SSB in the BWP of the SCell.

SCell is configured with OD-SSB in case that OnDemandSsbConfig is included in ServingCellConfigCommon or OnDemandNonCellDefiningSSB is included in ServingCellConfig.

Within the frequency span of a carrier, multiple SSBs can be transmitted. The PCIs of SSBs transmitted in different frequency locations do not have to be unique, i.e. different SSBs in the frequency domain can have different PCIs. However, when an SSB is associated with an RMSI, the SSB is referred to as a Cell-Defining SSB (CD-SSB). A PCell is always associated to a CD-SSB located on the synchronization raster.

When an SSB is not associated with an RMSI, the SSB is referred to as a non-Cell Defining SSB (NCD-SSB), which can be used to perform RLM, BFD, and RRM measurements and measurements for RA resource selection inside the active DL BWP when the active BWP does not contain the CD-SSB. A UE may be configured with multiple SSBs provided that each BWP is configured with at most one SSB (CD-SSB or NCD-SSB).

UE can perform followings with CD-SSB.
Synchronization;
RLM, BFD and RRM measurement;
measurement for RA resource selection.
SIB1 (RMSI) acquisition.

UE can perform followings with NCD-SSB.
RLM, BFD and RRM measurement;
measurement for RA resource selection.

SSB burst and half frame are used interchangeably. SSB may indicate an individual SSB or a SSBG.

A SSB burst (D100) consists of one or more SSBs. Each SSB is associated with a SSB index. First SSB (D120) is associated with SSB index 0, second SSB (D130) is associated with SSB index 1 and so on. SSB burst occurs periodically. The periodicity (D110) is configured by RRC.

SSB bursts having same periodicity and being on a same frequency are grouped together. They are called SSB burst group (SSBG). For example, D200 and D210 form a SSBG and D220, D230, D240 and D250 form another SSBG.

In case that AO-CD-SSB and OD-CD-SSB are on the same frequency, AO-CD-SSBs and OD-CD-SSBs belong to separate SSBGs. For example, D260 and D295 form SSBG 2 and D270, D280 and D290 form SSBG3.

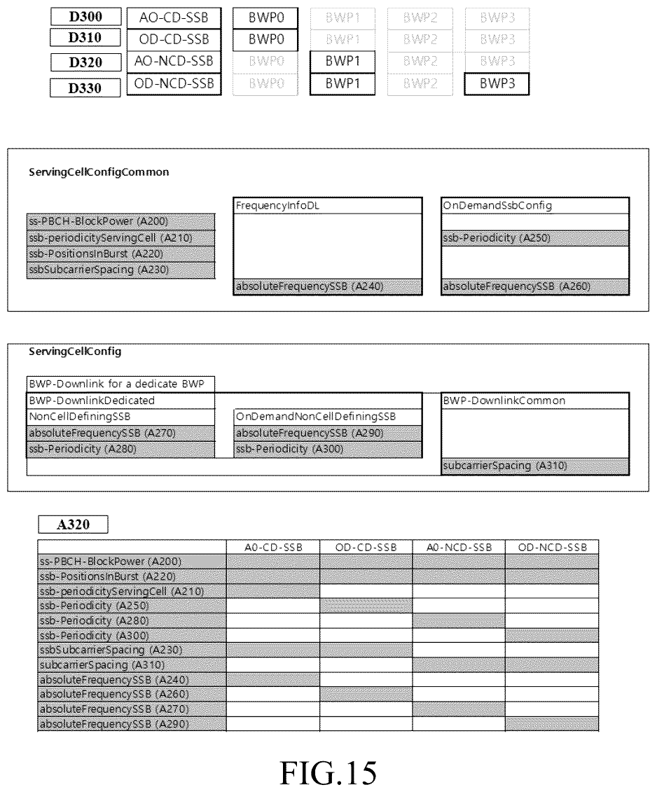

FIG. 15 illustrates various types of SSBs

In a single cell, various types of SSBs can be configured and transmitted.

Followings are always-on SSB.
AO-CD-SSB D300: Always on cell defining SSB. It is configured in BWP 0 (initial downlink BWP)
AO-NCD-SSB D320: Always on cell non defining SSB. It is configured in one or more BWPs that is not initial BWP

Followings are on-demand SSB burst.
OD-CD-SSB D310: cell defining SSB that is semi-persistently or aperiodically/irregularly transmitted. It is configured in BWP 0 (initial downlink BWP)
OD-NCD-SSB D330: cell non defining SSB that is semi-persistently or aperiodically/irregularly transmitted. It is configured in one or more BWPs that is not initial BWP

For a SCell:
ss-PBCH-BlockPower (A200) and ssb-PositionsInBurst (A220) are provided in ServingCellConfigCommon of the SCell;
ssb-periodicityServingCell (A210), ssb-Periodicity (A250), ssb-Periodicity (A280) and ssb-Periodicity (A300) are provided in ServingCellConfigCommon and in ServingCellConfig;
ssbSubcarrierSpacing (A230) and subcarrierSpacing (A310) are provided in ServingCellConfigCommon and in ServingCellConfig;
absoluteFrequencySSB (A240), absoluteFrequencySSB (A260), absoluteFrequencySSB (A270) and absoluteFrequencySSB (A290) are provided in ServingCellConfigCommon and in ServingCellConfig.

AO-CD-SSB is transmitted in the downlink initial BWP.
transmission power is indicated by ss-PBCH-BlockPower (A200) in ServingCellConfigCommon (of the SCell);
Transmission states of SSBs within a SSB burst is indicated by ssb-PositionsInBurst (A220) in ServingCellConfigCommon (of the SCell);
frequency of SSB is indicated by ssb-absoluteFrequencySSB (A240) in ServingCellConfigCommon (of the SCell);
periodicity of SSB burst is indicated by ssb-periodicityServingCell (A210) in ServingCellConfigCommon (of the SCell);
subcarrier spacing of SSB is indicated by ssbSubcarrierSpacing (A230) in FrequencyInfoDL in ServingCellConfigCommon (of the SCell).

AO-NCD-SSB is transmitted in a downlink RRC-configured BWP (or dedicated BWP).
Transmission states of SSBs within a SSB burst is indicated by ssb-PositionsInBurst (A220) in ServingCellConfigCommon (of the SCell);
frequency of SSB is indicated by absoluteFrequencySSB (A270) in NonCellDefining in BWP-Downlink (of the concerned BWP) in ServingCellConfig (of the SCell);
periodicity of SSB burst is indicated by ssb-periodicity (A280) in NonCellDefining in BWP-Downlink (of the concerned BWP) in ServingCellConfig (of the SCell);
subcarrier spacing of SSB is indicated by ssbSubcarrierSpacing (A310) in in BWP-Downlink (of the concerned BWP) in ServingCellConfig (of the SCell).

OD-CD-SSB is transmitted in the downlink initial BWP.
transmission power is indicated by ss-PBCH-BlockPower (A200) in ServingCellConfigCommon (of the SCell);
Transmission states of SSBs within a SSB burst is indicated by ssb-PositionsInBurst (A220) in ServingCellConfigCommon (of the SCell);
frequency of SSB is indicated by:
   absolute FrequencySSB (A260) in OnDemandSsbConfig in ServingCellConfigCommon (of the SCell); or
   ssb-absoluteFrequencySSB (A240) in ServingCellConfigCommon (of the SCell) in case that absoluteFrequencySSB (A260) is not present in OnDemandSsbConfig in ServingCellConfigCommon (of the SCell);
periodicity of SSB burst is indicated by ssb-periodicityServingCell (A250) in OnDemandSsbConfig in ServingCellConfigCommon (of the SCell);
subcarrier spacing of SSB is indicated by ssbSubcarrierSpacing (A230) in FrequencyInfoDL in ServingCellConfigCommon (of the SCell).

OD-NCD-SSB is transmitted in a downlink RRC-configured BWP (or dedicated BWP).
Transmission states of SSBs within a SSB burst is indicated by ssb-PositionsInBurst (A220) in ServingCellConfigCommon (of the SCell);
frequency of SSB is indicated by:
   absoluteFrequencySSB (A290) in OnDemandNonCellDefiningSSB in BWP-Downlink (of the concerned BWP) in ServingCellConfig (of the SCell); or
   absoluteFrequencySSB (A270) in NonCellDefining in BWP-Downlink (of the concerned BWP) in ServingCellConfig (of the SCell) in case that absoluteFrequencySSB (A290) is not present in OnDemandNonCellDefiningSSB in BWP-Downlink (of the concerned BWP) in ServingCellConfig (of the SCell);
periodicity of SSB burst is indicated by ssb-periodicity (A300) in OnDemandNonCellDefiningSSB in BWP-Downlink (of the concerned BWP) in ServingCellConfig (of the SCell);
subcarrier spacing of SSB is indicated by ssbSubcarrierSpacing (A310) in in BWP-Downlink (of the concerned BWP) in ServingCellConfig (of the SCell).

Parameters and BWP/SSB mapping A320
ss-PBCH-BlockPower (A200) is used by UE to determine average EPRE of the resources elements that carry secondary synchronization signals in all SSBs such as:
   SSBs in the initial bandwidth part (AO-CD-SSB & OD-CD-SSB) and SSBs in the first active bandwidth part (AO-CD-SSB and OD-CD-SSB in case that first active bandwidth part is initial bandwidth part; AO-NCD-SSB and OD-NCD-SSB in case that first active bandwidth part is one of dedicate BWP); and
SSBs in dedicate bandwidth parts (AO-NCD-SSB & OD-NCD-SSB).
ssb-PositionsInBurst (A220) is used by UE to determine time domain positions of all SSBs such as:
SSBs in the initial bandwidth part (AO-CD-SSB & OD-CD-SSB) and SSBs in the first active bandwidth part (AO-CD-SSB and OD-CD-SSB in case that first active bandwidth part is initial bandwidth part; AO-NCD-SSB and OD-NCD-SSB in case that first active bandwidth part is one of dedicate BWP); and
   SSBs in dedicate bandwidth parts (AO-NCD-SSB & OD-NCD-SSB).
ssb-periodicityServingCell (A210) is used by UE to determine periodicity of:
   AO-CD-SSB in the initial bandwidth part and in the first active bandwidth part (in case that the first active bandwidth part is initial bandwidth part).
ssb-Periodicity (A250) is used by UE to determine periodicity of:
   OD-CD-SSB in the initial bandwidth part and in the first active bandwidth part (in case that the first active bandwidth part is initial bandwidth part).
ssb-Periodicity (A280) is used by UE to determine periodicity of:
   AO-NCD-SSB in an associated dedicate bandwidth part.
ssb-Periodicity (A300) is used by UE to determine periodicity of:
   OD-NCD-SSB in an associated dedicate bandwidth part.
ssbSubcarrierSpacing (A230) is used by UE to determine subcarrier spacing of:
   SSBs in the initial bandwidth part (AO-CD-SSB & OD-CD-SSB) and SSBs in the first active bandwidth part in case that initial bandwidth part is first active bandwidth part.
subcarrierSpacing (A310) is used by UE to determine subcarrier spacing of:
   SSBs in dedicate bandwidth part (AO-NCD-SSB & OD-NCD-SSB).
absolute FrequencySSB (A240) is used by UE to determine frequency of:
   AO-CD-SSB in the initial bandwidth part and in the first active bandwidth part (in case that the first active bandwidth part is initial bandwidth part).
absoluteFrequencySSB (A260) is used by UE to determine frequency of:
   OD-CD-SSB in the initial bandwidth part and in the first active bandwidth part (in case that the first active bandwidth part is initial bandwidth part).
absoluteFrequencySSB (A270) is used by UE to determine frequency of:
   AO-NCD-SSB in an associated dedicate bandwidth part.
absoluteFrequencySSB (A290) is used by UE to determine frequency of:
   OD-NCD-SSB in an associated dedicate bandwidth part.

The SSB-based Measurement Timing Configuration (SMTC) enables efficient cell measurement and handover processes. SMTC provides the User Equipment (UE) with information regarding the measurement periodicity and timings of Synchronization Signal/Physical Broadcast Channel (SS/PBCH) blocks that can be used for measurements.

The UE shall setup the first SS/PBCH block measurement timing configuration (AO-SMTC or OD-SMTC) in accordance with the received periodicityAndOffset parameter (providing Periodicity and Offset value for the following condition) in the SSB-MTC configuration. The first subframe of each SMTC occasion occurs at an SFN and subframe of the NR SpCell meeting the following condition:

SFN mod T = (FLOOR (Offset/10));
if the Periodicity is larger than sf5:
subframe = Offset mod 10;
else:
subframe = Offset or (Offset +5);
with T = CEIL(Periodicity/10).

On the indicated absoluteFrequencySSB, the UE shall not consider a specific AO-SSB transmission in subframe outside the AO-SMTC occasion for the following measurements.
RRM measurements based on AO-SSB except for SFTD measurement.

On the indicated absoluteFrequencySSB, the UE shall consider the specific AO-SSB transmission in subframe inside the AO-SMTC occasion. UE performs the following measurements in subframe inside the AO-SMTC occasion.
RRM measurements based on AO-SSB;
SFTD measurement.

On the indicated absoluteFrequencySSB, the UE shall not consider the specific AO-SSB transmission in subframe outside the AO-SMTC occasion. UE performs the following measurements in subframe outside the AO-SMTC occasion.
SFTD measurement.

The specific AO-SSB is AO-CD-SSB in case that:
the SCell is deactivated; or
the SCell is activated and the currently active BWP is initial downlink BWP.

The specific AO-SSB is AO-NCD-SSB in case that:
the SCell is activated; and
the currently active BWP is RRC-configured downlink BWP.

On the indicated absoluteFrequencySSB, the UE shall not consider a specific OD-SSB transmission in subframe inside the OD-SMTC occasion for the following measurements if the specific OD-SSB is not activated (or is deactivated).
RRM measurements based on CD-SSB except for SFTD measurement.

On the indicated absoluteFrequencySSB, the UE shall not consider the specific OD-SSB transmission in subframe outside the OD-SMTC occasion for the following measurements if the specific OD-SSB is not activated (or is deactivated) or if the specific OD-SSB is activated.
RRM measurements based on CD-SSB except for SFTD measurement.

On the indicated absoluteFrequencySSB, the UE shall consider the specific OD-SSB transmission in subframe inside the OD-SMTC occasion for the following measurements if the specific OD-SSB is activated.
RRM measurements based on CD-SSB except for SFTD measurement.

On the indicated absoluteFrequencySSB, the UE performs following measurement, if the specific OD-SSB is activated, inside the OD-SMTC occasion.
RRM measurements based on CD-SSB;
SFTD measurement.

On the indicated absoluteFrequencySSB, the UE performs following measurement, if the specific OD-SSB is deactivated, inside the OD-SMTC occasion.
SFTD measurement.

On the indicated absoluteFrequencySSB, the UE performs following measurement, if the specific OD-SSB is activated, outside the OD-SMTC occasion.
SFTD measurement.

The specific OD-SSB is OD-CD-SSB in case that:
the SCell is deactivated and OD-SSB is activated; or
the SCell is activated, OD-SSB is activated and the currently active BWP is initial downlink BWP.

The specific OD-SSB is OD-NCD-SSB in case that:
the SCell is activated;
OD-SSB is activated;
the currently active BWP is not initial downlink BWP (e.g. RRC configured BWP).

SMTC for AO-CD-SSB of a SCell is provided in:
smtc field in SCellConfig of the SCell in case that smtc field is present in the SCellConfig; or
smtc1 field in measObjectNR having the same SSB frequency and subcarrier spacing (i.e. absoluteFrequencySSB (A240) and ssbSubcarrierSpacing (A230) are same as.

SMTC for AO-NCD-SSB is same as SMTC for AO-CD-SSB.

SMTC for OD-CD-SSB of a SCell is provided in smtc_od_ssb field in SCellConfig. The smtc_od_ssb field includes SSB-MTC IE.

SMTC for OD-NCD-SSB of the SCell is same as SMTC for OD-CD-SSB.

SMTC for AO-SSB (for either AO-CD-SSB or AO-NCD-SSB) is denoted as AO-SMTC.

SMTC for OD-SSB (for either OD-CD-SSB or OD-NCD-SSB) is denoted as OD-SMTC.

AO-SMTC is applied to the SCell when smtc field is configured for the SCell (or when SCell is configured; or when AO-SMTC is setup). UE considers AO-SMTC to be activated for the SCell if SCellConfig that contains a specific smtc field is received. The specific smtc field is smtc field that is set to setup.

OD-SMTC is applied to the SCell when smtc_od_ssb field is configured for the SCell (or when SCell is configured; or when OD-SMTC is setup) and OD-SSB is activated for the SCell.

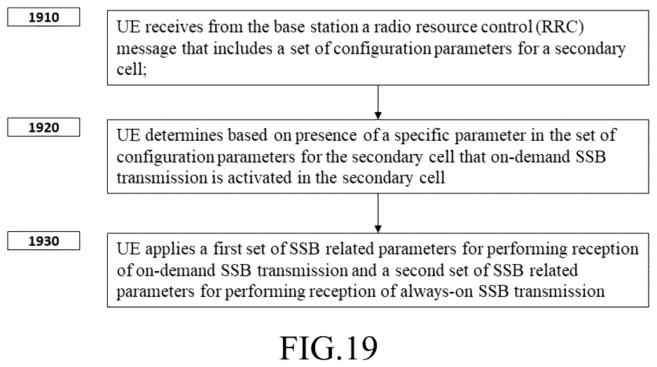

FIG. 19 is a diagram illustrating UE operations for on-demand SSB.

At 1910, the UE receives from the base station a radio resource control (RRC) message, wherein the RRC message includes a set of configuration parameters for a secondary cell;

At 1920, the UE determines based on presence of a specific parameter in the set of configuration parameters for the secondary cell that on-demand SSB transmission is activated in the secondary cell; and

At 1930, the UE applies a first set of SSB related parameters for performing reception of on-demand SSB transmission and a second set of SSB related parameters for performing reception of always-on SSB transmission.

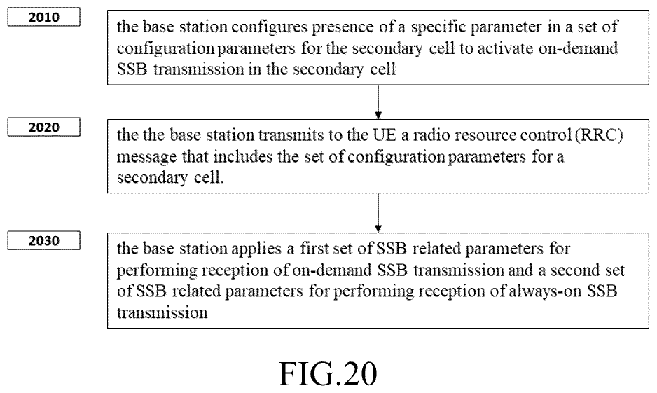

FIG. 20 is a diagram illustrating base station operations for on-demand SSB.

At 2010, the base station configures presence of a specific parameter in a set of configuration parameters for the secondary cell to activate on-demand SSB transmission in the secondary cell.

At 2020, the base station transmits to the UE a radio resource control (RRC) message, wherein the RRC message includes the set of configuration parameters for a secondary cell.

At 2030, the base station applies a first set of SSB related parameters for performing reception of on-demand SSB transmission and a second set of SSB related parameters for performing reception of always-on SSB transmission.

The first set of SSB related parameters include a first parameter for SSB periodicity, a first parameter for SSB power and a parameter for SSB position. The second set of SSB related parameters includes a second parameter for SSB periodicity, a second parameter for SSB power and the parameter for SSB position. The first set of SSB related parameters and the second set of SSB related parameters are included in the set of configuration parameters for the secondary cell.

The SCell Activation/Deactivation MAC CE of one octet is identified by a MAC subheader with LCID. It has a fixed size and consists of a single octet containing seven C-fields and one R-field. The SCell Activation/Deactivation MAC CE with one octet is defined.

The SCell Activation/Deactivation MAC CE of four octets is identified by a MAC subheader with LCID. It has a fixed size and consists of four octets containing 31 C-fields and one R-field. The SCell Activation/Deactivation MAC CE of four octets is defined as follows
Cᵢ: If there is an SCell configured for the MAC entity with SCellIndex i this field indicates the activation/deactivation status of the SCell with SCellIndex i, else the MAC entity shall ignore the Cᵢ field. The Cᵢ field is set to 1 to indicate that the SCell with SCellIndex i shall be activated. The Cᵢ field is set to 0 to indicate that the SCell with SCellIndex i shall be deactivated;
R: Reserved bit, set to 0.

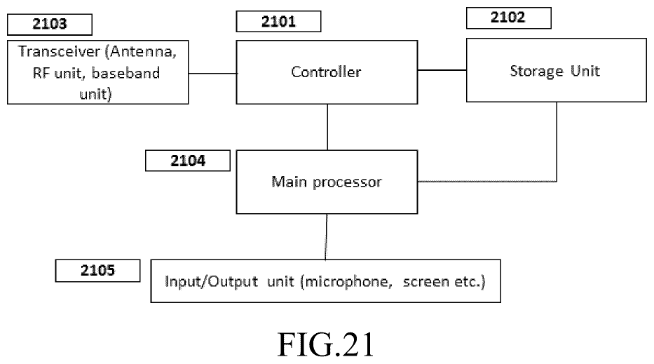

FIG. 21 is a block diagram illustrating the internal structure of a Terminal to which the disclosure is applied.

Referring to the diagram, the terminal includes a controller (2101), a storage unit (2102), a transceiver (2103), a main processor (2104) and I/O unit (2105).

The controller (2101) controls the overall operations of the terminal in terms of mobile communication. For example, the controller (2101) receives/transmits signals through the transceiver (2103). In addition, the controller (2101) records and reads data in the storage unit (2102). To this end, the controller (2101) includes at least one processor. For example, the controller (2101) may include a communication processor (CP) that performs control for communication and an application processor (AP) that controls the upper layer, such as an application program. The controller controls storage unit and transceiver such that UE operations illustrated in this disclosure are performed.

The storage unit (2102) stores data for operation of the terminal, such as a basic program, an application program, and configuration information. The storage unit (2102) provides stored data at a request of the controller (2101).

The transceiver (2103) consists of a RF processor, a baseband processor and plurality of antennas. The RF processor performs functions for transmitting/receiving signals through a wireless channel, such as signal band conversion, amplification, and the like. Specifically, the RF processor up—converts a baseband signal provided from the baseband processor into an RF band signal, transmits the same through an antenna, and down—converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (2104) controls the overall operations other than mobile operation. The main processor (2104) process user input received from I/O unit (2105), stores data in the storage unit (2102), controls the controller (2101) for required mobile communication operations and forward user data to I/O unit (2105).

I/O unit (2105) consists of equipment for inputting user data and for outputting user data such as a microphone and a screen. I/O unit (2105) performs inputting and outputting user data based on the main processor's instruction.

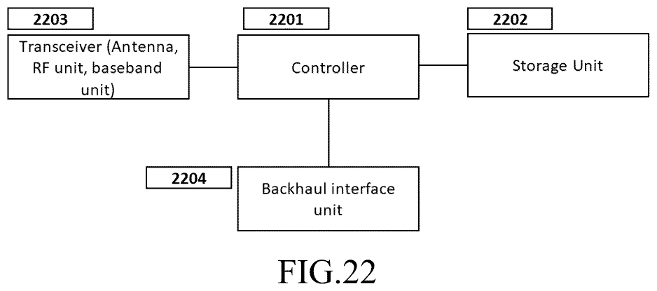

FIG. 22 is a block diagram illustrating the configuration of a base station according to the disclosure.

As illustrated in the diagram, the base station includes a controller (2201), a storage unit (2202), a transceiver (2203) and a backhaul interface unit (2204).

The controller (2201) controls the overall operations of the main base station. For example, the controller (2201) receives/transmits signals through the transceiver (2203), or through the backhaul interface unit (2204). In addition, the controller (2201) records and reads data in the storage unit (2202). To this end, the controller (2201) may include at least one processor. The controller controls transceiver, storage unit and backhaul interface such that base station operation illustrated in this disclosure are performed.

The storage unit (2202) stores data for operation of the main base station, such as a basic program, an application program, and configuration information. Particularly, the storage unit (2202) may store information regarding a bearer allocated to an accessed UE, a measurement result reported from the accessed UE, and the like. In addition, the storage unit (2202) may store information serving as a criterion to determine whether to provide the terminal with multi-connection or to discontinue the same. In addition, the storage unit (2202) provides stored data at a request of the controller (2201).

The transceiver (2203) consists of a RF processor, a baseband processor and plurality of antennas. The RF processor performs functions for transmitting/receiving signals through a wireless channel, such as signal band conversion, amplification, and the like. Specifically, the RF processor up—converts a baseband signal provided from the baseband processor into an RF band signal, transmits the same through an antenna, and down—converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (2204) provides an interface for communicating with other nodes inside the network. The backhaul interface unit (2204) converts a bit string transmitted from the base station to another node, for example, another base station or a core network, into a physical signal, and converts a physical signal received from the other node into a bit string.

Below lists acronym used in the present disclosure.

| | | | |
|---|---|---|---|
| 5GC | 5G Core Network | RACH | Random Access Channel |
| ACK | Acknowledgement | RAN | Radio Access Network |
| AM | Acknowledged Mode | RAR | Random Access Response |
| AMF | Access and Mobility Management Function | | |
| RA-RNTI | Random Access RNTI | | |
| ARQ | Automatic Repeat Request | RAT | Radio Access Technology |
| AS | Access Stratum | RB | Radio Bearer |
| ASN.1 | Abstract Syntax Notation One | RLC | Radio Link Control |
| BSR | Buffer Status Report | RNA | RAN-based Notification Area |
| BWP | Bandwidth Part | RNAU | RAN-based Notification Area Update |
| CA | Carrier Aggregation | RNTI | Radio Network Temporary Identifier |
| CAG | Closed Access Group | RRC | Radio Resource Control |
| CG | Cell Group | RRM | Radio Resource Management |
| C-RNTI | Cell RNTI | RSRP | Reference Signal Received Power |
| CSI | Channel State Information | RSRQ | Reference Signal Received Quality |
| DCI | Downlink Control Information | RSSI | Received Signal Strength Indicator |
| DRB | (user) Data Radio Bearer | SCell | Secondary Cell |
| DTX | Discontinuous Reception | SCS | Subcarrier Spacing |
| HARQ | Hybrid Automatic Repeat Request | | |
| SDAP | Service Data Adaptation Protocol | | |
| IE | Information element | SDU | Service Data Unit |
| LCG | Logical Channel Group | SFN | System Frame Number |
| MAC | Medium Access Control | S-GW | Serving Gateway |
| MIB | Master Information Block | SI | System Information |
| NAS | Non-Access Stratum | SIB | System Information Block |
| NG-RAN | NG Radio Access Network | SpCell | Special Cell |
| NR | NR Radio Access | SRB | Signalling Radio Bearer |
| PBR | Prioritised Bit Rate | SRS | Sounding Reference Signal |
| PCell | Primary Cell | SS | Search Space |
| PCI | Physical Cell Identifier | SSB | SS/PBCH block |
| PDCCH | Physical Downlink Control Channel | | |
| SSS | Secondary Synchronisation Signal | | |
| PDCP | Packet Data Convergence Protocol | SUL | Supplementary Uplink |
| PDSCH | Physical Downlink Shared Channel | | |
| TM | Transparent Mode | | |
| PDU | Protocol Data Unit | UCI | Uplink Control Information |
| PHR | Power Headroom Report | UE | User Equipment |
| PLMN | Public Land Mobile Network | UM | Unacknowledged Mode |
| PRACH | Physical Random Access Channel | | |
| CRP | Cell Reselection Priority | | |
| PRB | Physical Resource Block | PSS | Primary Synchronisation Signal |
| PUCCH | Physical Uplink Control Channel | | |
| PUSCH | Physical Uplink Shared Channel | | |

What is claimed is:

1. A method performed by a terminal, the method comprising:
receiving, from a base station, a radio resource control (RRC) message;
receiving, from the base station, a medium access control (MAC) control element (CE) for activating an on-demand synchronization signal block (OD-SSB), wherein the MAC CE comprises a bitmap;
activating the OD-SSB in a downlink bandwidth part of a serving cell in case that a bit of the bitmap corresponding to the serving cell is set to one, wherein a bit position in the bitmap is determined based on a Secondary Cell (SCell) index of the serving cell; and
setting up an OD-SSB-specific Synchronization Signal/Physical Broadcast Channel (SS/PBCH) block measurement timing configuration (SMTC) for the serving cell in case that the serving cell is activated.

2. The method of claim 1, wherein:
transmission of the OD-SSB starts at a specific point of time; and
the specific point of time is determined based on a transmission time of a hybrid automatic repeat request acknowledgment (HARQ-ACK) for the MAC CE on a Physical Uplink Control Channel (PUCCH) and a first OD-SSB parameter.

3. The method of claim 2, wherein the RRC message comprises:
the first OD-SSB parameter indicating a time offset between OD-SSB transmission and OD-SSB activation command reception;
a second OD-SSB parameter indicating a periodicity of OD-SSB transmission;
a third OD-SSB parameter indicating an absolute frequency of the OD-SSB;
a fourth OD-SSB parameter indicating an initial activation state of the OD-SSB; and
a fifth OD-SSB parameter indicating a number of OD-SSB groups per activation.

4. The method of claim 3, wherein:
a plurality of OD-SSB groups are transmitted when the OD-SSB is activated;
a number of the plurality of OD-SSB groups is determined based on the fifth OD-SSB parameter; and
each OD-SSB group comprises a plurality of OD-SSBs transmitted within a same half-frame.

5. A terminal comprising:
a transceiver; and
a processor configured to control the transceiver to:
receive, from a base station, a radio resource control (RRC) message; and
receive, from the base station, a medium access control (MAC) control element (CE) for activating an on-demand synchronization signal block (OD-SSB), wherein the MAC CE comprises a bitmap;
wherein the processor is further configured to:
activate the OD-SSB in a downlink bandwidth part of a serving cell in case that a bit of the bitmap corresponding to the serving cell is set to one, wherein a bit position in the bitmap is determined based on a Secondary Cell (SCell) index of the serving cell; and
set up an OD-SSB-specific Synchronization Signal/Physical Broadcast Channel (SS/PBCH) block measurement timing configuration (SMTC) for the serving cell in case that the serving cell is activated.

6. A base station comprising:
a transceiver; and
a processor configured to control the transceiver to:
transmit, to a terminal, a radio resource control (RRC) message;
transmit, to the terminal, a medium access control (MAC) control element (CE) for activating an on-demand synchronization signal block (OD-SSB), wherein the MAC CE comprises a bitmap; and
transmit the OD-SSB in a downlink bandwidth part of a serving cell,
wherein a bit of the bitmap corresponding to the serving cell is set to one, and
wherein a bit position in the bitmap is determined based on a Secondary Cell (SCell) index of the serving cell.

7. The base station of claim 6, wherein:
transmission of the OD-SSB starts at a specific point of time; and
the specific point of time is determined based on a reception time of a hybrid automatic repeat request acknowledgment (HARQ-ACK) for the MAC CE on a Physical Uplink Control Channel (PUCCH) from the terminal and a first OD-SSB parameter.

8. The base station of claim 7, wherein the RRC message comprises:
the first OD-SSB parameter indicating a time offset between OD-SSB transmission and OD-SSB activation command reception;
a second OD-SSB parameter indicating a periodicity of OD-SSB transmission;
a third OD-SSB parameter indicating an absolute frequency of the OD-SSB;
a fourth OD-SSB parameter indicating an initial activation state of the OD-SSB; and
a fifth OD-SSB parameter indicating a number of OD-SSB groups per activation.

9. The base station of claim 8, wherein:
a plurality of OD-SSB groups are transmitted when the OD-SSB is activated;
a number of the plurality of OD-SSB groups is determined based on the fifth OD-SSB parameter; and
each OD-SSB group comprises a plurality of OD-SSBs transmitted within a same half-frame.
